(19) United States
(12) Patent Application Publication
(10) Pub. No.: US 2006/0218026 A1
(43) Pub. Date: Sep. 28, 2006

(54) Administrative system

(76) Inventor: Peter J. Osborne, Andrews, Queensland (AU)

Correspondence Address: Christine A Lekutis;Medlen & Carroll, Suite 350, 101 Howard Street, San Francisco, CA, 94105, US

(21) Appl. No.: 10/549,432

(22) PCT Filed: Mar. 22, 2004
(86) PCT No.: PCT/AU04/00353

§ 371 Date: May 15, 2006

Related U.S. Application Data
(60) Provisional application No. 60/456,863, filed on Mar. 21, 2003.

(51) Int. Cl. G05B 19/418

(52) U.S. Cl. 705/8

(57) ABSTRACT

An apparatus for processing data for the administration of an organisation includes a data storage device storing element data representing details of workplace elements. At least one recordal device is configured to record activity data associated with the workplace elements by recording the element data during workplace activities associated with the workplace elements. At least one computer is operable on the data storage device, is connected to the, or each, recordal device, is programmed to write the activity data to the data storage device, to generate activity codes associated with the activity data and to write said activity codes to a database in the data storage device together with said activity data. The, or each computer is further programmed to retrieve the element data and the activity data from the database using said activity codes and to apply predetermined algorithms to the element and activity data to generate reports relating to workplace activities associated with the workplace elements.

### FIELD OF THE INVENTION

This invention relates to an administrative system. More particularly, this invention relates to a method and to an apparatus for processing data for the administration of an organisation.

### BACKGROUND OF THE INVENTION

Administration of organisations having multi-departmental workplaces has always been a highly specialized task, having aspects such as inventory control, personnel management, quality control and other features.

In some organisations, a deficiency in administration can have dangerous results. An example of such a workplace is a hospital. For example, a loss of control over cleaning procedures can lead to septicaemia and possible death of patients. This is an extreme example. However, in many other workplaces control of inventory and quality are extremely important.

At present, in organisations having a number of different locations and departments, different control procedures are often applied to separate yet similar departments. This can result in a breakdown of efficient operation. One of the reasons for this is that the functioning of each department becomes dependent on the skills of a particular manager. This can lead to inconsistency and duplication, especially where the organisation has similar workplaces, such as hospitals, positioned at different locations.

In this specification, particular attention is directed to the administration of hospitals. It will, however, be appreciated that the invention can readily be applied to other organ isations that have similar administrative requirements.

In hospitals, a number of risks require management. These include:
i. Malfunction or breakdown of surgical instruments.
ii. Breakdown in sterilization process management.
iii. Cross contamination between surgical instruments.
iv. Tracing and isolating potential sources of infection.
v. Management of diseases such as CJD, VRE, AIDS etc.
vi. Patient to patient infection outbreaks.
vii. Access to reliable historical information relating to elements of particular events.
viii. Historical information relating to sterile goods, consumables and pharmaceuticals.
ix. Prosthetic implant administration and batch tracking requirements.
x. Profitability of particular surgical procedures.

It will be appreciated that efficient procedural management is extremely difficult, if not impossible, to achieve if each department or each hospital is subjected to discrete management techniques. Applicant submits that consistent procedures in each department or hospital are essential for the reduction of risk.

Applicant has conceived this invention to provide a means whereby activities and use of inventory in such organisations can be recorded. Furthermore, the invention provides a means whereby control of such activities and use of inventory is facilitated to achieve consistency across an entire organisation.

In order to achieve these advantages, the invention provides a means whereby data can readily be obtained from the various layers of a typical hierarchical structure. This is critical in facilitating managerial control over various activities carried out at the different levels.

An important form of data to extract would be that relating to the profitability of individual activities. This, together with other data obtained would allow the micro-management of various activities in order to achieve the maximum profit from such activities.

At present, management of hospitals often involves over-rationalization in an attempt to address perceived problems. For example in a process that involves a large number of steps, it is difficult to determine which of the steps is leading to inefficiency in the process as a whole. In an attempt to address this inefficiency, management must often rely on anecdotal reports and instinct to make decisions. As a result, management decisions are often not based on an accurate knowledge of a particular process in a hospital. This invention provides a means for making detailed activity data available to hospital management, so that effective and cost-efficient decisions can be made.

### DEFINITIONS

In this specification, the following words are to be understood as having the meanings as set out below:

“An organisation”—Any form of structured arrangement that includes personnel and equipment that are combined to provide services or products. For example, a healthcare organisation such as public healthcare organisations or a healthcare organisations that administer a number of hospitals, or even a single hospital is covered by this phrase.

“Workplace”—A location under the control of an organisation where some form of work is carried out. For example a hospital, a department in a hospital, a division in a department, a section of a division or a unit where only one form of work is carried out can all fall under this definition.

“Workplace activities”—Various activities that are carried out in a workplace, such as X-ray procedures, sterilisation procedures or administrative procedures carried out in a healthcare organisation.

“Workplace elements”—Elements that can be associated with particular activities carried out at a workplace. These include such elements as surgical instruments, sterile items, sterilisers, medical personnel, etc. in a healthcare organisation. The definition extends to groups of elements associated with a particular activity.

“Computer”—Any computational device such as a personal computer (PC), mainframe, or the like.

“Professional”—In the case of a healthcare organisation, any person who would be regarded as a medical professional. This definition would include, for example, doctors, surgeons, anaesthetists etc.

### SUMMARY OF THE INVENTION

According to a first aspect of the invention, there is provided a method of processing data for the administration of an organisation, the method including the steps of:

generating element data representing details of workplace elements;

recording activity data associated with the workplace elements by recording the element data during workplace activities associated with the workplace elements;

writing the element data and the activity data to a database stored in a data storage device;

associating activity codes with the element data and the activity data; retrieving the element data and the activity data from the database using the activity codes as keys for such retrieval; and

applying predetermined algorithms to the element data and the activity data to generate reports relating to workplace activities associated with the workplace elements.

The step of generating element data may include the step of building a registration database that includes at least one look up table that stores element codes and the element data such that each element code represents a predetermined component of the element data associated with that element code.

The step of generating element data may include the step of converting each element code in the registration database into a barcode and applying the barcode to respective workplace elements. The step of recording the element data may include the step of scanning the barcodes.

The step of writing the element data and the activity data to a database may include the step of writing the element codes to intermediate files together with defining parameters such as date and time data and the activity codes, such that each activity is associated with an intermediate file.

The method may include the step of generating a delimited text file for each activity, with the element codes, the activity code and the defining parameters of that activity, to define the intermediate file, such that each field of the delimited text file contains one variable element code, the activity code and the remaining element codes.

The method may include the step of importing data from the delimited text files to imported data tables, such that each row of each imported data table represents a field of the associated delimited text file, with one column of each imported data table containing variable element codes and a number of columns of each imported data table containing said remaining element codes.

The method may include the step of expanding at least one of the element codes representing a group of workplace elements into element codes representing the workplace elements of that group.

Start and finish time details may be imported into a column of the imported data table.

The method may include the steps of carrying out a look-up operation on the registration database and the imported data tables and generating save tables so that each save table has a column of activity codes and columns of workplace element details and so that each activity code can be associated with a set of workplace element details.

The step of applying predetermined algorithms to the element data and the activity data to generate reports may include the step of calculating cost components associated with various workplace activities and generating account reports.

According to a second aspect of the invention, there is provided an apparatus for processing data for the administration of an organisation, the apparatus including

a data storage device storing element data representing details of workplace elements;

at least one recordal device that is configured to record activity data associated with the workplace elements by recording the element data during workplace activities associated with the workplace elements; and

at least one computer, that is operable on the data storage device, is connected to the, or each, recordal device, is programmed to write the activity data to the data storage device, to generate activity codes associated with the activity data and to write said activity codes to a database in the data storage device together with said activity data, the, or each computer being further programmed to retrieve the element data and the activity data from the database using said activity codes and to apply predetermined algorithms to the element and activity data to generate reports relating to workplace activities associated with the workplace elements.

The apparatus may include a primary computer and at least one secondary computer connected to the primary computer with a suitable network. The primary computer may be programmed to generate the activity codes and to store the activity and element data together with the associated activity codes in the data storage device.

The primary computer may be programmed to apply said predetermined algorithms to the element and activity data to generate the reports.

The data storage device may store a registration database that includes at least one look up table that stores element codes and the element data such that each element code represents a predetermined component of the element data associated with that element code.

One of the primary computer and the, or each, secondary computer may be programmed to generate barcodes, each barcode representing an element code and capable of being operatively applied to each workplace element. The, or each, recordal device may be a programmable barcode scanner that is connected to the, or each, secondary computer via the network.

The apparatus may include a plurality of barcode scanners. Each barcode scanner may be capable of reading said barcodes and may be configured to generate a signal representing the element code corresponding to the scanned barcode.

Each barcode scanner may be programmed to be associated with a particular activity, such that each barcode scanner is configured to read barcodes in a predetermined order when that activity is carried out.

The primary computer may be programmed to write the element codes to intermediate files together with defining parameters such as date and time data and the activity codes, such that each activity is associated with an intermediate file.

The primary computer may be programmed to generate a delimited text file for each activity, with the element codes, the activity code and the defining parameters of that activity, to define the intermediate file, such that each field of the delimited text file contains one variable element code, the activity code and the remaining element codes.

The primary computer may be programmed to import data from the delimited text files to imported data tables, such that each row of each imported data table represents a field of the associated delimited text file, with one column of each imported data table containing variable element codes and a number of columns containing said remaining element codes.

The primary computer may be programmed to expand at least one of the element codes representing a group of workplace elements into element codes representing the workplace elements of that group.

The primary computer may be programmed to import start and finish time details into a column of the imported data table.

The primary computer may be programmed to carry out a look up operation on the registration database and the imported data tables and to generate save tables, so that each save table has a column of activity codes and columns of workplace element details and so that each activity code can be associated with a set of workplace element details.

The primary computer may be programmed to calculate cost components associated with various workplace activities and to generate account reports.

The element codes may be in the form of datastrings.

Said predetermined algorithms may be any number of algorithms that may be useful for facilitating administration of an organisation. For example, if the workplace element is an employee, the computer may be programmed to retrieve an hourly rate and duration of an activity to calculate the cost of that employee. If the workplace element is an item of inventory, the computer may be programmed to retrieve a purchase price and serial number and to perform an amortization calculation on the purchase price. It will be appreciated that it would be impractical to mention all the administrative algorithms that could be carried out. In short, however, it will be appreciated that administrative algorithms can readily be generated for the calculation of profitability of selected activities.

The method may include the step of generating readable group codes that represent groups of workplace elements associated with a particular procedure. Thus, the method may include the step of reading a group code when carrying out a related procedure so that use of the workplace elements associated with that particular code is automatically recorded. It will be appreciated that this obviates the need to read a code applied to each workplace element every time a particular procedure is carried out.

The apparatus is particularly suited for the administration of a healthcare organisation. Thus, the primary computer may be positioned at an administrative centre and any number of secondary computers may be positioned at various hospitals under the care of the administrative centre. The primary computer and the secondary computers may be in communication with each other via a suitable network, such as an intranet or the World Wide Web (WWW).

According to a third aspect of the invention, there is provided a method of tracking workplace inventory, the method including the steps of:

generating element data relating to a predetermined set of workplace elements associated with a predetermined workplace procedure;

applying a readable code to the data;

reading the code when said predetermined workplace procedure is carried out to generate usage data relating to the set of workplace elements; and

applying predetermined algorithms to the element data and the usage data to generate record data.

According to a fourth aspect of the invention, there is provided a computer for processing data for the administration of an organisation, the computer including a data storage device storing element data representing details of workplace elements the computer being connectable to at least one recordal device that is configured to record activity data associated with the workplace elements by recording the element data during workplace activities associated with the workplace elements, the computer being programmed to be operable on the data storage device, to write the activity data to the data storage device, to generate activity codes associated with the activity data and to write said activity codes to a database in the data storage device together with said activity data, the computer being further programmed to retrieve the element data and the activity data from the database using said activity codes and to apply predetermined algorithms to the element and activity data to generate reports relating to workplace activities associated with the workplace elements.

The invention is now described, by way of example, with reference to the accompanying drawings. The following description is for illustrative purposes and is not intended to reduce the scope of the preceding paragraphs.

### BRIEF DESCRIPTION OF THE DRAWINGS

In the drawings:

FIG. 1 shows a schematic layout of an apparatus for administering a healthcare organisation.

FIG. 2 shows, schematically, a database structure for the generation of barcodes to be used with the apparatus of FIG. 1.

FIG. 3 shows a flowchart indicating the input of data relating to the preparation for a procedure into a computer of the apparatus of FIG. 1.

FIG. 4 shows a flowchart indicating the input of data for a fixed procedure to be carried out on a patient into the computer of the apparatus of FIG. 1.

FIG. 5 shows a flowchart indicating the input of data for a sterilization process into the computer of the apparatus of FIG. 1.

FIG. 6 shows a flowchart indicating the input of data for a further fixed procedure into the computer of the apparatus of FIG. 1.

FIG. 7 shows a flowchart indicating the input of data for a flexible theatre procedure into the computer of the apparatus of FIG. 1.

FIG. 8 shows, schematically, a process for a scanning procedure to be undertaken in a theatre of a hospital.

FIG. 9A shows an intermediate imported data table generated as a result of the scanning procedure indicated in FIG. 8.

FIG. 9B shows a flowchart indicating a process applied to data in the table of FIG. 9A.

FIG. 10A shows a data table generated by the process shown in FIG. 9B.

FIG. 10B shows a flowchart broadly indicating a process applied to the data table of FIG. 9B in order to achieve a series of saved tables of data.

FIG. 11A shows part of a flowchart for a program that writes the data in the table of FIG. 10 to save tables.

FIG. 11B shows a further part of a flowchart for a program that writes the data in the table of FIG. 10 to save tables.

FIG. 11C shows a further part of a flowchart for a program that writes the data in the table of FIG. 10 to save tables

FIG. 12 shows a save table of patient details generated by the program of FIG. 11.

FIG. 13 shows a save table of operation details generated by the program of FIG. 11.

FIG. 14 shows a save table of assets generated by the program of FIG. 11.

FIG. 15 shows a save table of process trays generated by the program of FIG. 11.

FIG. 16 shows a save table of professional details generated by the program of FIG. 11.

FIG. 17 shows a save table of products generated by the program of FIG. 11.

FIG. 18 shows a save table of prosthetics generated by the program of FIG. 11.

FIG. 19 shows a save table of staff members generated by the program of FIG. 11.

FIG. 20 shows a flow chart of a program applied to the save tables of FIGS. 12 to 19.

FIG. 21 shows a save table of totals generated by the program of FIG. 20.

FIG. 22 shows a pair of barcode tabs generated from the database of FIG. 2 to be applied to a tray of sterilized surgical instruments.

FIG. 23 shows an interface for the input of data relating to surgical instruments to the computer of FIG. 1.

FIG. 24 shows an interface for the input of data for the creation of a staff barcode to the database structure of FIG. 2.

FIG. 25 shows an interface for the input of data relating to a steriliser to the database structure of FIG. 2.

FIG. 26 shows an interface for the input of data relating to a prosthesis to the database structure of FIG. 2.

FIG. 27 shows an interface for the input of data relating to an area name and department associated with a procedure to the database structure of FIG. 2.

FIG. 28 shows an interface for the input and display of data relating to an operation procedure code.

FIG. 29 shows an interface for the input and display of data relating to a patient.

FIG. 30 shows an interface for the input and display of data relating to assets.

FIG. 31 shows an interface for the input and display of data relating to a product.

FIG. 32 shows an interface for the input and display of data relating to a hospital.

FIG. 33 shows an interface for the input and display of data relating to a department.

FIG. 34 shows an interface for allowing an operator to set up the apparatus of FIG. 1.

FIG. 35 shows, schematically, a user interface of a scanner used to input data to a delimited text file.

FIG. 36 shows a user interface for the input of data relating to preparation for a procedure to the computer of FIG. 1.

FIG. 37 shows a hierarchical structure applied to a database generated by a program of the invention.

FIG. 38 shows a flowchart of a procedure used to process group barcodes.

FIG. 39 shows a group barcode and the elements associated with that group barcode.

FIG. 40 shows a flowchart of a sterilisation procedure carried out in accordance with a method of the invention.

FIG. 41A shows a first part of a printout of a table of components of a particular surgical tray.

FIG. 41B shows a second part of a printout of the table of components.

FIG. 42A shows a first part of a printout of a patient's theatre records generated by the apparatus of FIG. 1.

FIG. 42B shows a second part of the printout.

FIG. 43 shows a flowchart of a hierarchical structure that indicates an application of the invention.

### DETAILED DESCRIPTION OF THE INVENTION

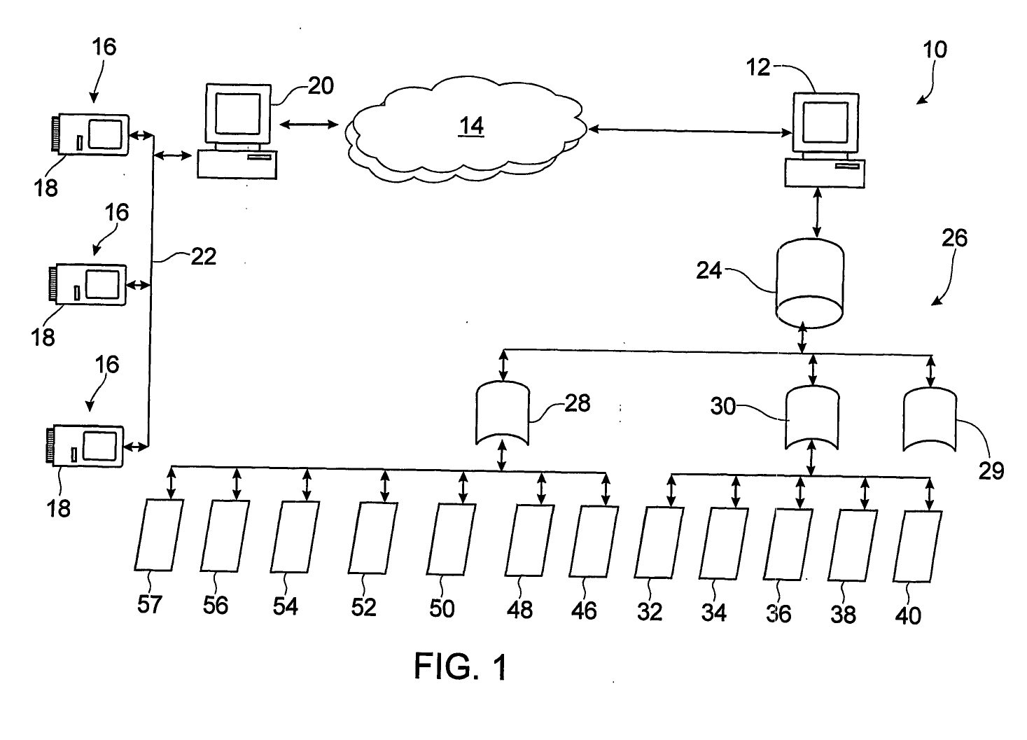

In FIG. 1, reference numeral 10 generally indicates an apparatus, in accordance with the invention, for the administration of a healthcare organisation.

The apparatus 10 includes a primary computer 12. The primary computer 12 is connected to a network 14. The network 14 can be in the form of the World Wide Web (WWW) or in the form of a conventional intranet, depending on the application of the apparatus 10.

The apparatus 10 includes a number of secondary computers, one of which is shown at 20, for the sake of convenience. The secondary computer 20 is also connected to the network 14.

Still further, the apparatus 10 includes a number of scanning stations, three of which are shown at 16, for the sake of convenience. The scanning stations 16 include scanners 18 that are connected to an intranet 22, which, in turn, is connected to the secondary computer 20.

It is to be appreciated that the secondary computer 20 and the scanning stations 16 can be at one workplace location and the primary computer 12 can be at another workplace location. Thus, the secondary computer 20 and the scanning stations 16 can be at a particular hospital, while the primary computer 12 can be at an administrative centre. Thus, as will be seen below, the apparatus 10 provides a means whereby administrative control of a number of hospitals at a single administrative centre can be achieved.

Applicant submits that the schematic representation shown in FIG. 1 can be shown in a number of different ways, while still achieving the goal of central control, and not departing from the scope of the invention.

The scanners 18 are programmable scanners of the type which include a display and a keyboard to facilitate the reading and input of data by an operator. The manner in which the scanners 18 are programmed is described in greater detail below.

The secondary computer 20 is configured to receive datastrings generated by the scanners 18 and to communicate these datastrings to the primary computer 12.

The secondary computer 20 is also configured to permit an operator to enter data relating to workplace elements and to communicate this data to the primary computer 12, to be stored in a data storage device 24 connected to the computer 12.

The data storage device 24 carries a database 26. The database 26 is divided into a registration database 28, an administrative database 30 and a record database 29.

The administrative database 30 contains data relating to all workplace elements of hospitals under the administrative control of the primary computer 12.

The administrative database 30 is divided into a consumables directory 32, a patient directory 34, an inventory directory 36, a staff directory 38, and a medical professionals directory 40. It will readily be appreciated that any number of further directories could be provided, depending on the application of the apparatus 10.

The data in the administrative database 30 is conventional in the sense that it includes data that would usually be entered in an administrative control system. For example, the consumables directory 32 includes serial numbers, cost and date of purchase of the consumables. The patient directory 34 includes such details as name, date of birth, medical aid organization, etc. The inventory directory 36 includes inventory description, date of purchase, purchase price, usage counts, amortizing amounts, allocation costs, etc. The staff directory 38 includes the staff number, the hourly rate, the staff member names, the staff member titles etc. The medical professionals directory 40 includes the names, the fees, and the positions of the medical professionals.

The registration database 28 contains codes that are associated with the various elements of the administrative database 30. As will be seen later, the scanners 18 are used to generate datastrings that are then used by the primary computer 12 to perform a look-up operation in the registration database 28 to identify the workplace elements associated with the datastrings.

Thus, the registration database 28 includes a medical professional code directory 46, a staff code directory 48, a patient code directory 50, an asset code directory 52, a product code directory 54, a group code directory 56 (described in greater detail below), and an activity code directory 57 (also described in greater detail below). Again, depending on the application of the apparatus 10, any number of further code directories can be provided.

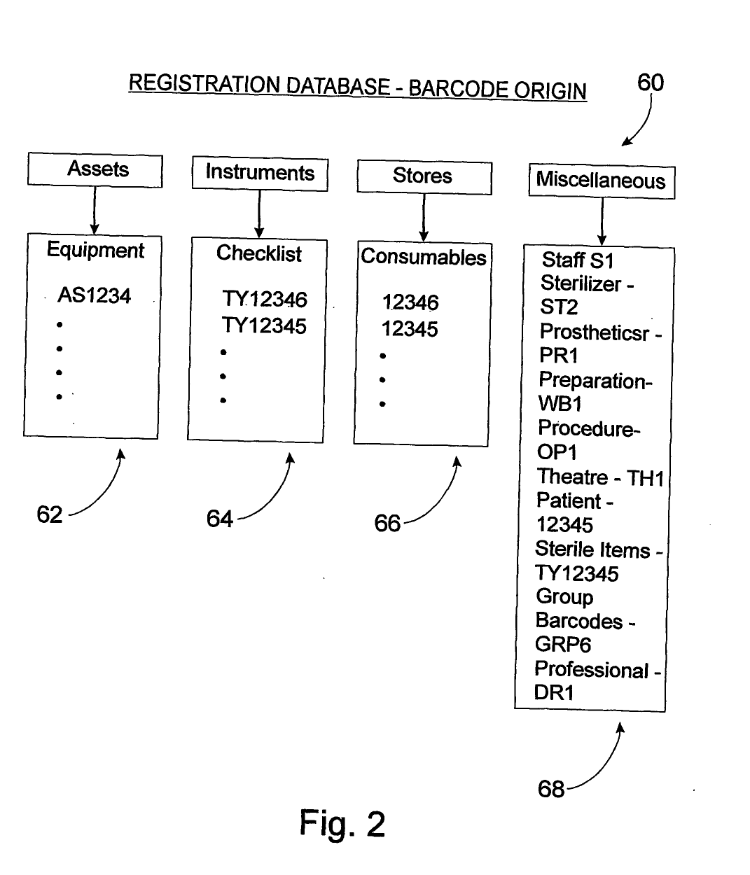

In FIG. 2, reference numeral 60 generally indicates a possible table structure of the registration database 28.

The table structure 60 is divided into an asset table 62, an instruments table 64, a stores table 66 and a miscellaneous table 68.

The asset table 62 includes datastrings relating to equipment. The datastrings have identifiers in the form of prefixes, in this case, the prefix “AS”. The prefix ensures that the data relating to the equipment is stored in the correct location in the registration database 28 and in other tables described below.

The instrument table 64 includes datastrings relating to trays of equipment. It will be appreciated that each tray is associated with a predetermined set of instruments. Thus, as set out in more detail below, each tray has a barcode applied to it that it is associated with a particular set of instruments and represents one of the datastrings. The datastrings have an identifier or prefix, in this case “TY”.

The stores table 66 includes datastrings relating to consumables stored by the hospital. It will be appreciated that most consumables, especially those sold for use in the medical industry, are labelled with a barcode which represents a serial number. For convenience, these numbers can be stored in the table 66. It follows that these numbers do not necessarily have a prefix.

The miscellaneous table 68 includes datastrings relating to other workplace elements. In particular, staff datastrings, with a prefix “S”, sterilizer datastrings, with a prefix “ST”, prosthetics datastrings, with a prefix “PR”, preparation area datastrings, with a prefix “WB”, procedure datastrings, with a prefix “OP”, theatre datastrings, with a prefix “TH”, patient datastrings, with no prefix, sterile item datastrings, with a prefix “TY”, group datastrings, with the prefix “GRP”, and professional datastrings, with the prefix “DR”, described below, are stored in the table 68.

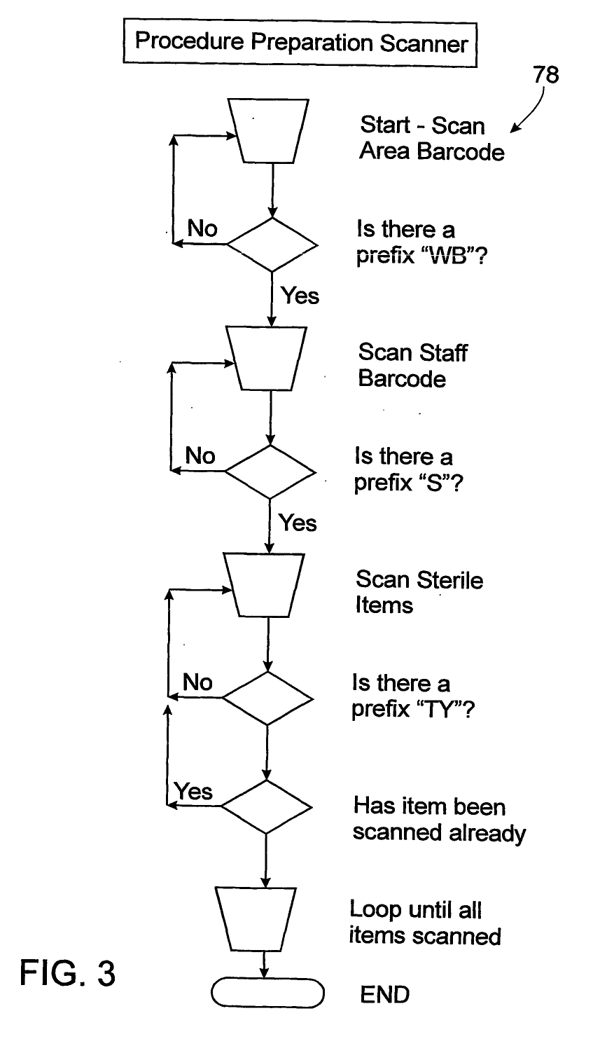

In FIG. 3, there is shown a flowchart 78 that indicates a data entry process that is used to generate datastrings associated with a particular preparation area. In particular, the flow chart 78 indicates a possible configuration of the programmable scanner 18 that can be used with the method of the invention.

Initially, a barcode that is suitably positioned is scanned. If a prefix “WB”, which indicates that the barcode is associated with a preparation area, is recorded, the scanner 18 displays an instruction to scan barcodes carried by the staff members. Further, the scanner 18 communicates a preparation area datastring to the computer 12 via the network 14 and the computer 20. This is described in greater detail below.

If no prefix “WB” is recorded, the scanner 18 is programmed to return to a start condition, which is displayed on the interface of the scanner 18.

If, when scanning the staff member barcode, the scanner 18 records an “S” prefix, then the scanner 18 displays an instruction to scan barcodes of sterile items used in the preparation area. Further, the scanner 18 communicates details of the staff member datastring to the computer 12 via the network 14 and the computer 20.

If no prefix “S” is recorded, the scanner 18 is programmed to return to a condition for scanning staff member barcodes, which is displayed by the scanner 18.

If, when the operator scans the barcodes of the sterile items, the scanner 18 does not record a prefix “TY”, the scanner 18 is programmed to return to a condition for scanning sterile item barcodes, which is displayed by the scanner 18.

If, when scanning the sterile item barcodes, the scanner 18 records the prefix “TY”, the computer 20 queries the database 26, via the computer 12, to check if that particular sterile item has been recorded. If the query response is positive, the computer 20 instructs the scanner 18 to return to the condition for scanning sterile items. If the query response is negative, the computer 20 communicates details of the sterile item datastring to the computer 12, via the network 14.

It will be appreciated that the above mechanism directs an operator to continue scanning until details of all the workplace elements have been communicated to the computer 12.

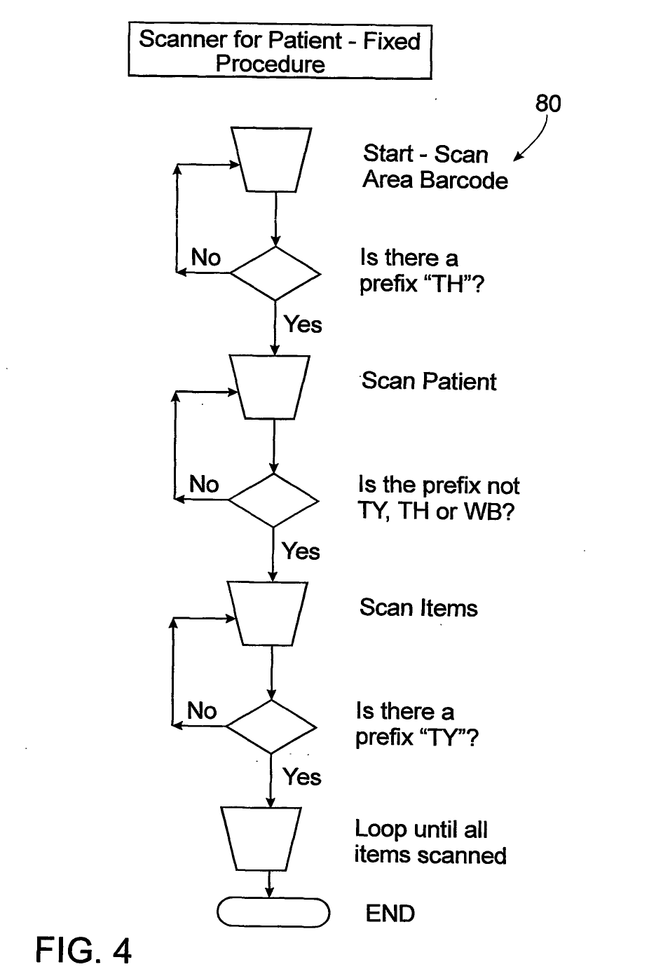

In FIG. 4, reference numeral 80 generally indicates a flowchart that indicates the manner in which data relating to a fixed procedure carried out in a particular theatre can be retrieved with the scanner 18 in conjunction with the computer 20.

Initially, an operator scans an area barcode positioned in a suitable location in a particular workplace area, with the scanner 18.

The scanner 18 is programmed so that, if the scanner 18 records a prefix “TH” the scanner 18 displays an instruction to scan a patient barcode. Further, the scanner communicates a datastring representing the theatre barcode to the computer 12 via the computer 20 and the network 14.

If the scanner 18 does not record the prefix “TH” in the theatre datastring, then the scanner 18 is programmed to return to a start condition, which is indicated by the scanner 18.

As set out earlier, the datastrings relating to patient codes do not have a prefix. It follows that the absence of a prefix indicates that the datastring represents a patient code. Thus, if the scanner 18 records either the prefixes: “TY”, “TH”, or “WB”, when the operator scans the patient barcode, then the scanner 18 returns to a condition for scanning a patient barcode.

Alternatively, the scanner 18 displays an instruction to the operator to scan barcodes of sterile items. Further, the scanner 18 communicates the patient datastring to the computer 12, via the computer 20 and the network 14.

The scanner 18 is programmed so that if the scanner 18 records a prefix “TY” when a sterile item barcode is scanned, the scanner 18 communicates the sterile item datastring to the computer 12, via the computer 20 and the network 14. The operator can thus continue until all the sterile item barcodes are scanned.

If the scanner 18 does not record a prefix “TY”, then the scanner 18 returns to a condition in which it is configured to scan sterile items, which is displayed by the scanner 18.

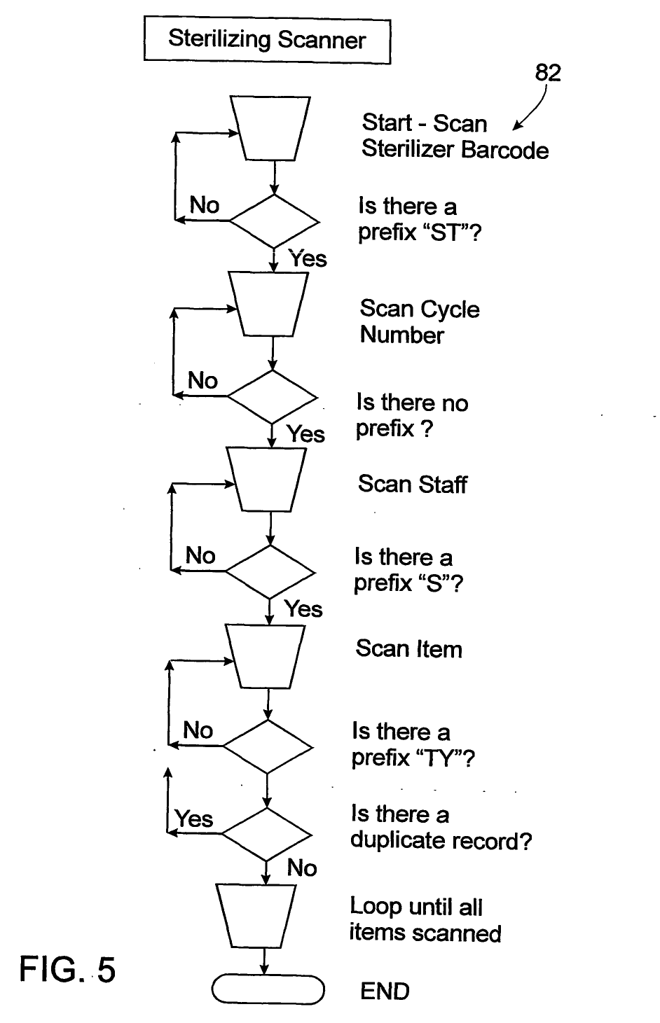

In FIG. 5, reference numeral 82 generally indicates a flowchart indicating the manner in which the scanner 18 can be used to retrieve datastrings which are then used to record details of a sterilisation procedure.

Initially, a steriliser barcode is scanned. This barcode can be applied to any convenient location on the steriliser.

The scanner 18 is programmed so that if a prefix “ST” is recorded, the scanner 18 displays an instruction to the operator to scan a cycle number of the steriliser. Further, the scanner 18 communicates a datastring that represents the steriliser to the computer 12, via the computer 20 and the network 14.

If the scanner 18 does not record the prefix “ST”, the scanner 18 is programmed to return to the start condition, which is indicated by the scanner 18.

The cycle number is not associated with any prefix. Thus, if the scanner 18 does not record any prefix when scanning the cycle number, the scanner 18 is programmed to display an instruction to the operator to scan a barcode of a staff member operating the steriliser. Further, the scanner communicates the cycle number to the computer 12 via the computer 20 and the network 14.

If the scanner 18 does record a prefix, the scanner 18 is programmed to return to the condition in which the cycle number can be scanned, which is displayed by the scanner 18.

When scanning the staff member barcode, if the scanner 18 records the prefix “S”, the scanner 18 displays an instruction to scan a barcode relating to the item or items to be sterilised. Further, the scanner communicates a datastring representing the staff member barcode to the computer 12, via the computer 20 and the network 14.

If the scanner 18 does not record the prefix “S” the scanner 18 is programmed to return to a condition for scanning the staff barcode, which is displayed to the operator.

When scanning the sterile item barcode, if the scanner 18 records the prefix “TY”, the computer 20 queries, via the network 14 and the computer 12, whether there is a duplicate record of that particular item. If the query returns a positive, the scanner 18 is programmed to return to the condition in which the scanner 18 is ready to scan an item barcode. If the query returns a negative, the scanner 18 permits the operator to continue to scan other item barcodes.

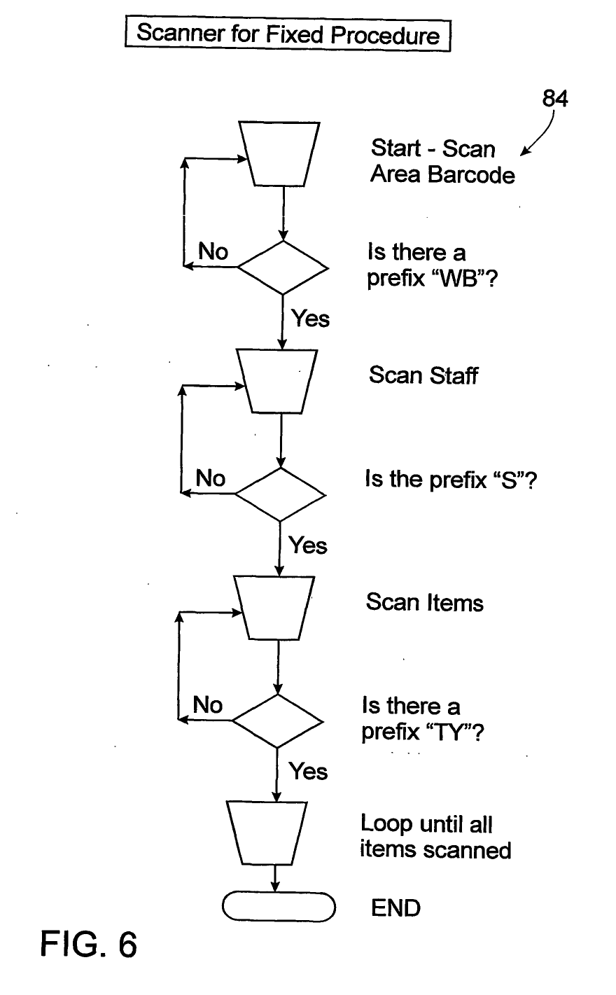

In FIG. 6, reference numeral 84 generally indicates a flowchart for indicating the manner in which the scanner 18 can be used, with the computer 20, to record details of a fixed procedure carried out in a hospital.

Initially, an area barcode is scanned in the area in which the fixed procedure is to take place.

If the scanner 18 records a prefix “WB”, the scanner is programmed to display an instruction to scan barcodes of staff members involved in the procedure. Further, the scanner 18 communicates a datastring representing the preparation area to the computer 12, via the computer 20 and the network 14.

If the scanner 18 does not record the prefix “WB”, the scanner 18 is programmed to return to a start condition, which is indicated to the operator.

The scanner 18 is programmed so that, when scanning the staff barcode, if the scanner 18 records a prefix “S” on the staff barcode, the scanner 18 displays an instruction to begin scanning barcodes of the items to be used in the area. Further, the scanner 18 communicates a datastring representing the staff member to the computer 12 via the computer 20 and the network 14.

If the scanner does not record the prefix “S” on the staff barcode, the scanner 18 is programmed to return to a condition in which it is ready to scan the staff member barcode, which is displayed to the operator.

When scanning the item barcodes, if the scanner 18 records a prefix “TY”, the scanner 18 displays this to the operator and permits the operator to scan further items. Further, the scanner 18 communicates a datastring representing the item barcode to the computer 12 via the computer 20 and the network 14.

If the scanner 18 does not record a prefix “TY”, then the scanner 18 returns to the condition in which the scanner 18 is ready to record item barcodes, which is displayed to the operator.

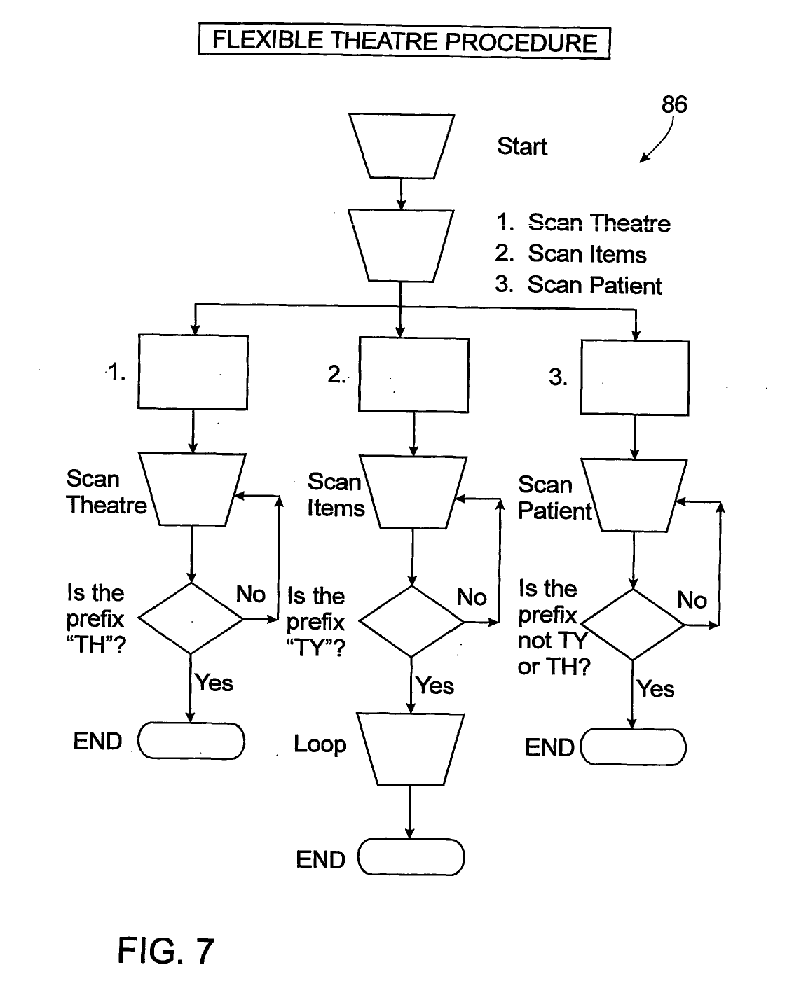

In FIG. 7, reference numeral 86 generally indicates a flowchart indicating the manner in which the scanner 18 can be used, together with the computer 20, to record the details of a flexible theatre procedure, i.e. a procedure in a particular theatre, which may differ from time to time.

Initially, the scanner 18 is programmed to permit an operator to select either a theatre scan process, or a scan items process or a scan patient process.

The scanner 18 is programmed so that, if the operator selects the theatre scan process, the scanner 18 records, as a first step, theatre barcodes only. Thus, if the scanner 18 records the prefix “TH”, the scanner 18 communicates a datastring representing the theatre to the computer 12, via the computer 20 and the network 14. Further, the scanner 18 displays an end of the theatre scan process to the operator and then prompts the operator to select either a scan items process or a scan patient process.

The scanner 18 is programmed so that, if the operator selects the scan items process, the scanner records, as a first step, item barcodes only. Thus, if the scanner records the prefix “TY”, the scanner communicates a datastring representing the item to the computer 12 via the computer 20 and the network 14. Further, the scanner 18 displays an instruction to the operator to scan the next item. The operator can thus continue until all the items have been scanned.

If the scanner 18 does not record the prefix “TY”, the scanner 18 returns to a condition in which the scanner 18 is ready to begin scanning items, which is indicated to the operator.

Once all the items have been scanned, the scanner 18 is programmed to prompt the operator to begin scanning the patient barcodes.

The scanner 18 is programmed so that if the scanner 18 does not record a prefix “TY” or “TH”, the scanner 18 communicates a datastring representing the patient barcode to the computer 12 via the computer 20 and the network 14. Further, the scanner 18 displays a message that the process is ended.

If the scanner 18 does record a prefix “TY” or “TH”, the scanner 18 returns to a scan patient condition, which is displayed to the operator.

The flowcharts 78 to 86 show a few of a number of ways in which the scanner 18 can be programmed to direct certain steps for the collection of information. It will readily be appreciated that a large number of variances in the programs can be achieved to collect information relating to other aspects of medical practice.

In particular, it should be appreciated that the scanner 18 is programmed to facilitate the collection of information, such that the information is collected in an orderly manner and, in particular, such that the information is not duplicated.

It will be appreciated that an operator could scan an incorrect workplace element that is accepted by the computer 20 as it falls into the correct category. For example, the operator could scan an incorrect asset, prosthetic or tray of sterile items. Thus, the apparatus 10 includes reset barcodes that are provided in convenient locations or supplied with the scanner 18. The scanner 18 and the computer 20 are programmed so that when the reset barcode is scanned, follow by the barcode of the workplace element that was incorrectly scanned, the computer 20 deletes the data entry relating to the incorrectly scanned workplace element. The scanner 18 is programmed subsequently to prompt the operator to scan the correct workplace element.

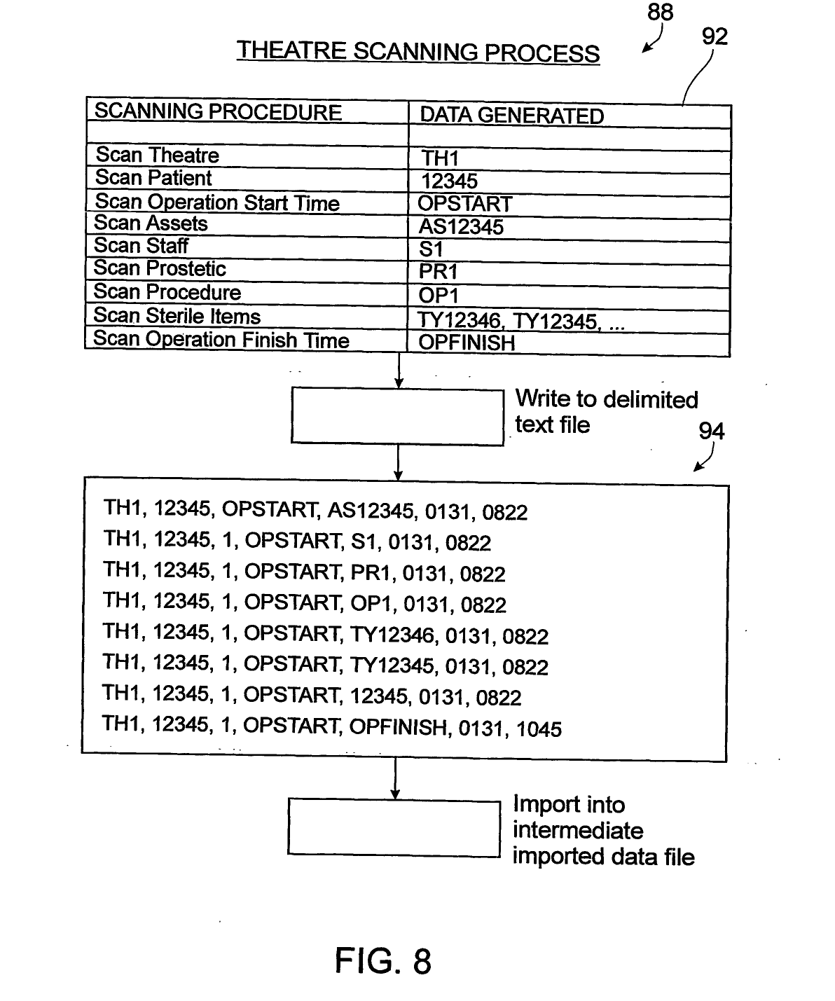

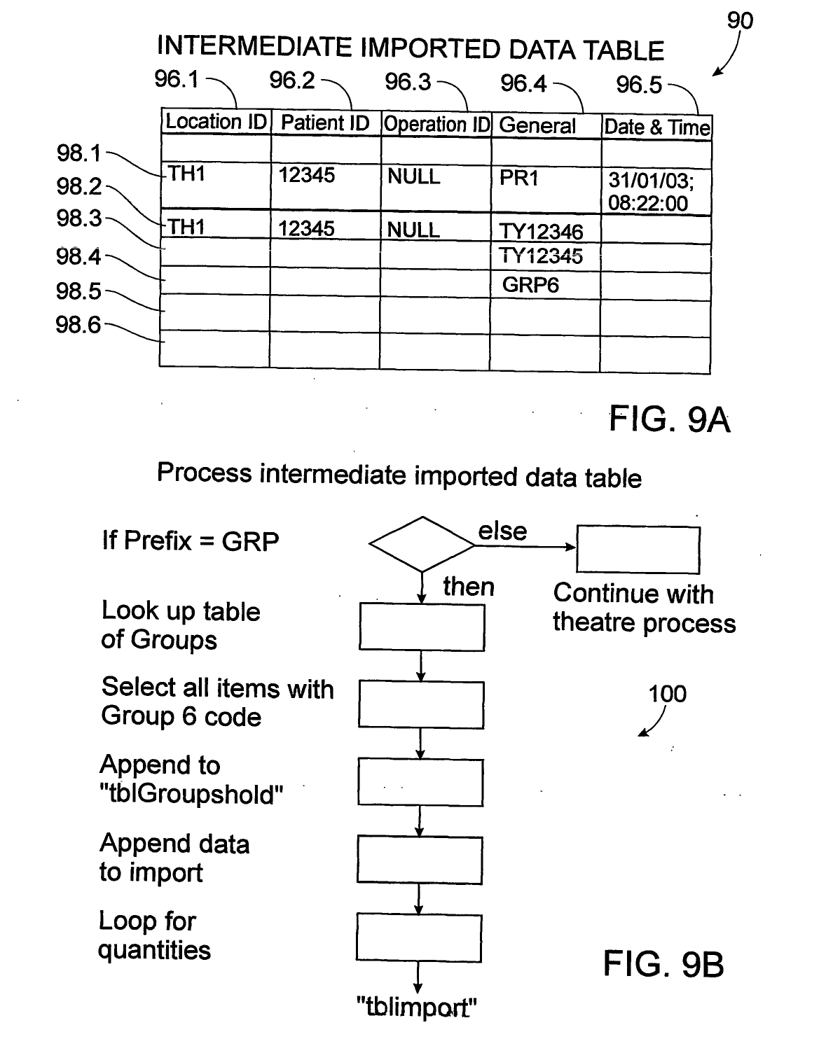

In FIG. 8, reference numeral 88 generally indicates a flowchart that sets out the manner in which the datastrings recorded by the scanner 18, as described above, are imported into an intermediate data table, shown as 90 in FIG. 9, during one particular workplace activity.

It will be appreciated that it is important that the information collected by the scanning process mentioned above be readily available for the generation of reports. In order to achieve this, the primary computer 12 is programmed to generate an activity code that is associated with each set of datastrings generated by the scanner 18 when the scanner 18 records the information at a particular activity. The activity codes are then stored in the activity code directory 57. It will thus be appreciated that at any time, the directory 57 contains a set of activity codes that are associated with respective activities. It follows that the primary computer 12 can be programmed to retrieve sets of information associated with particular activity codes. Importantly, the activity codes are never duplicated. Thus, each code is associated with a particular activity that would have taken place in the workplace. For example, if the particular activity was an operation, the activity code can serve to link all the elements of that activity. The importance of this will be apparent when the save tables are described below.

Reference numeral 92 shows a table containing data recorded as a result of the scanning operations described above. The table 92 is simply a description of the datastrings generated by the scanner 18 and is self-explanatory.

The computer 12 is programmed to write the datastrings into a delimited text file represented at 94. As is known, such files store data such that each entry or, in this case, datastring, is separated by a character (which is a comma in this case) and each field is separated by a line separator. Each field can contain any combination of datastrings depending on requirements.

As can be seen in the delimited text file 94, each line of datastrings includes the datastring “1” which is the activity code that represents the activity that is recorded by the scanning process described above. In this particular example, as soon as the next activity is carried out, an activity code “2” is generated and linked with all the elements of that activity.

It is important to note that the activity codes are unique and independent. It follows that activity code “2” could represent another activity that is completely unrelated to the activity associated with code “1”. This allows the activity codes to be used as an effective data mining parameter. For example, each patient in the hospital will be associated with one or more unique activity codes. This permits the computer 12 to be programmed to retrieve all data that may be associated with that particular patient, by using simple queries. Furthermore, each activity code provides a unique way of retrieving costs and thus profit/loss associated with each activity. For example, all the activity codes associated with a particular patient provide a link to all elements that were associated with each activity. Each element has a certain cost associated with that element. Thus, the costs of each element associated with a particular activity can be retrieved. This allows the computer 12 to be programmed to generate profit/loss data associated with each element of a particular activity. Thus, an administrator can readily identify those aspects of a particular activity which are inefficient and therefore a cost burden.

The computer 12 is programmed to write the datastrings in the file 94 to the intermediate imported data table 90, shown in FIG. 9A.

The intermediate imported data table 90 consists of five columns 96. A first column 96.1 contains datastrings relating to a particular area in a hospital. A second column 96.2 contains datastrings relating to the identification of a patient that is the subject of the workplace activity. A third column 96.3 contains datastrings relating to the identification of an operation to be carried out on the patient. A fourth column 96.4 contains datastrings relating to general data. A fifth column 96.5 contains datastrings relating to dates and times.

In this particular workplace activity, there is a single location, TH1 (theatre no. 1), a single patient (i.d. 12345), no operation (NULL) a number of general items, a start time of 08:22:00 on 31 Jan. 2003 and a finish time of 08:45:23 on 31 Jan. 2003.

The datastrings in the fourth column 96.4 relate to, from top to bottom, a prosthetic (PR1), a sterile item (TY12346), a further sterile item (TY12345), A group (GRP6) (which is described below), a start time (OPSTART) and a finish time (OPFINISH).

As can be seen, the table 90 is organized into rows 98 that associate each datastring in the general column 96.4 with datastrings in the other column. Thus, a first row 98.1 associates theatre no. 1, patient i.d. 12345, no operation, prosthetic “PR1” and a start time of 08:22:00 on 31 Jan. 2003, and so on.

In each case, it will be appreciated that the choice of symbols for the datastrings is largely random and, provided consistency is maintained, any symbol or group of symbols could be selected.

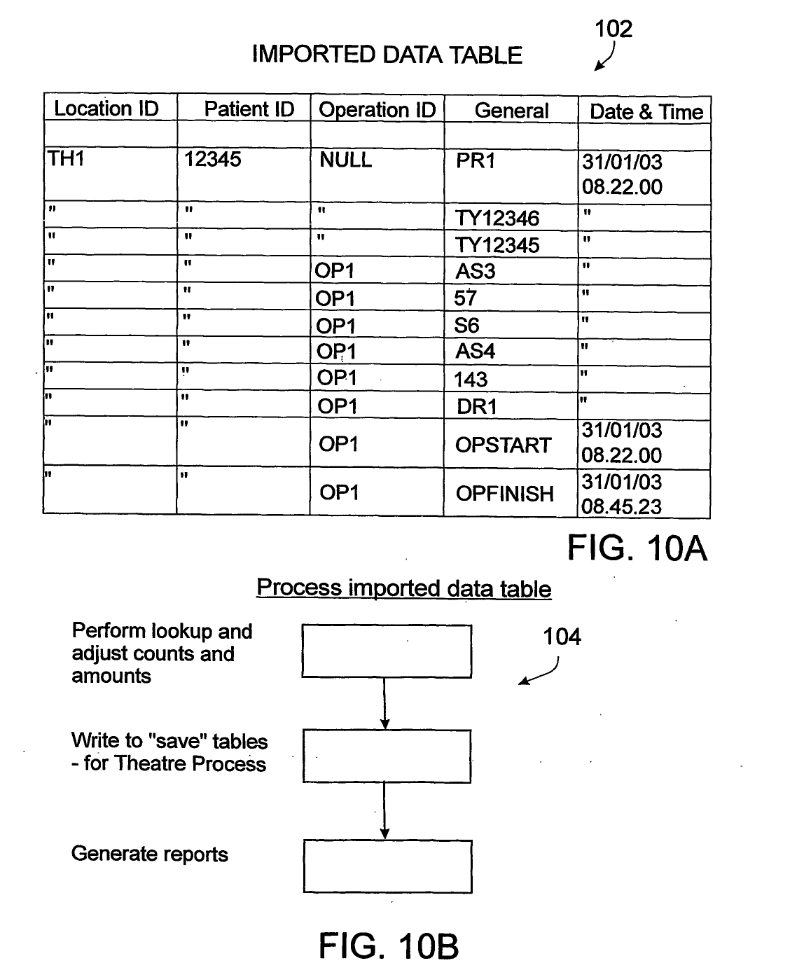

In FIG. 9B, reference numeral 100 generally indicates a flowchart of a manner in which the computer 12 is programmed to process the datastrings in the table 90. In particular, the flowchart 100 indicates the manner in which the group datastring in column 96.4 of the table 90 is separated into its individual datastrings which, together with the remaining datastrings of the table 90, are written to an imported data table 102 shown in FIG. 10A.

Thus, the program is initiated by the query as to whether a prefix “GRP” exists in any of the datastrings in column 96.4. Again, this could be any string of symbols or characters and “GRP” is selected for the sake of convenience and recognition. If the query returns a positive, then the program performs a look up operation on the directory of group codes 56 and returns a particular group of codes, in this case, group code GRP6. If the query returns a negative, the program continues with the writing of the table 90 to the table 102.

In returning GRP6, the program selects all codes associated with GRP6. The relevance of the group codes is described further below.

The program appends the datastrings relating to GRP6 to a holding table, which is labelled “tblGroupsHold”. The program loops through these datastrings to determine quantities of each of the datastrings in the particular group.

The program then writes the resultant datastrings to the imported data table 102. As can be seen in FIG. 10A, the table 102 is similar to the table 90, with the difference being that the “GRP6” datastring has been expanded into its various element codes. In this case, those codes represent an operation “OP1”, which is associated with the prosthetic code “PR1”, an asset code “AS3”, a consumable code “57”, a staff member code “S6”, a further asset code “AS4”, a further consumable code “143” and a professional code “DR1”. As set out in the table 102, these elements can readily be associated with a particular location, a patient, an operation and a date and time.

The relevance of DR1 being associated with GRP6 is discussed in detail below.

In FIG. 10B, reference numeral 104 generally indicates, broadly, a flowchart of a program used to process the imported data table 102, to generate reports.

In a first stage, the program performs look up operations on the table 102 and adjusts counts and amounts in the database 26. The program then writes the information from the table 102 to various save tables that are described below. Finally, the program is configured to generate reports from the save tables and to write the reports to the record database 29.

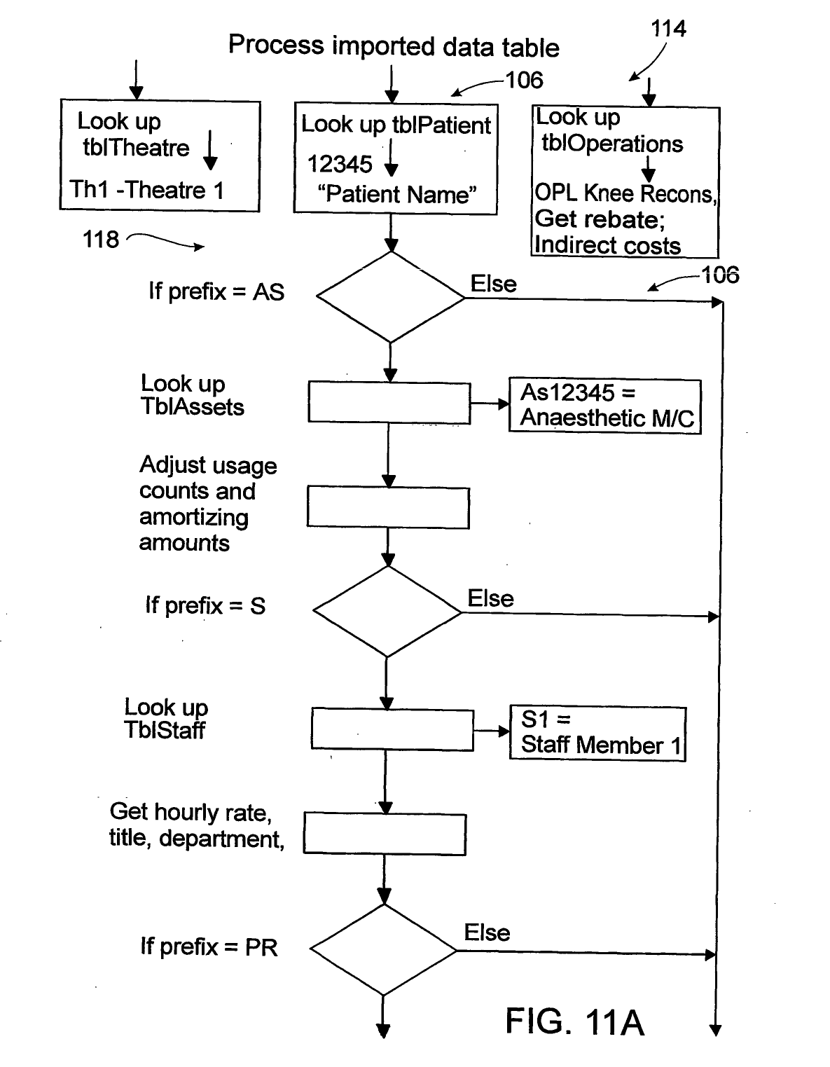

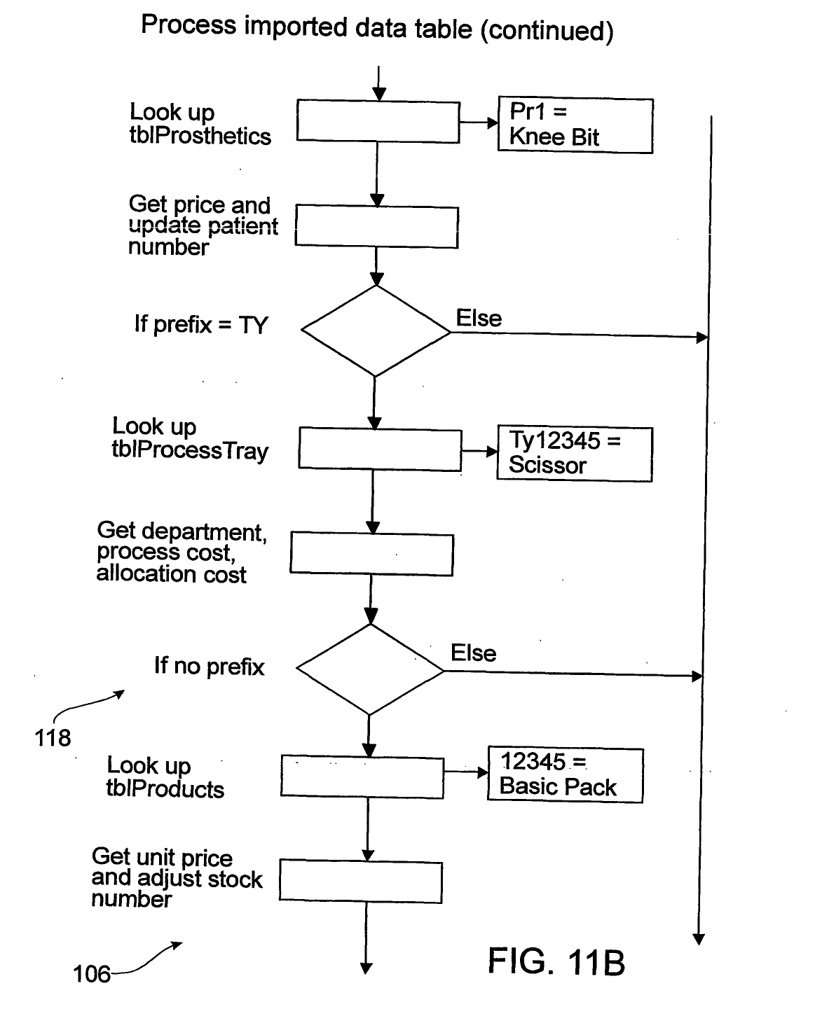

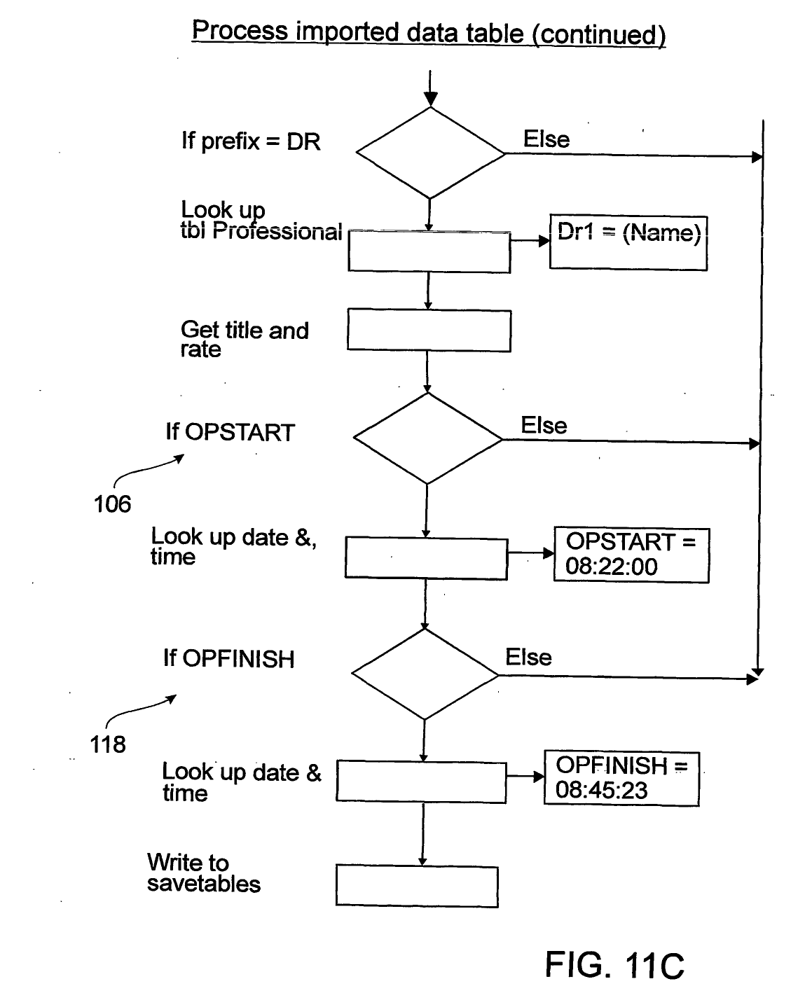

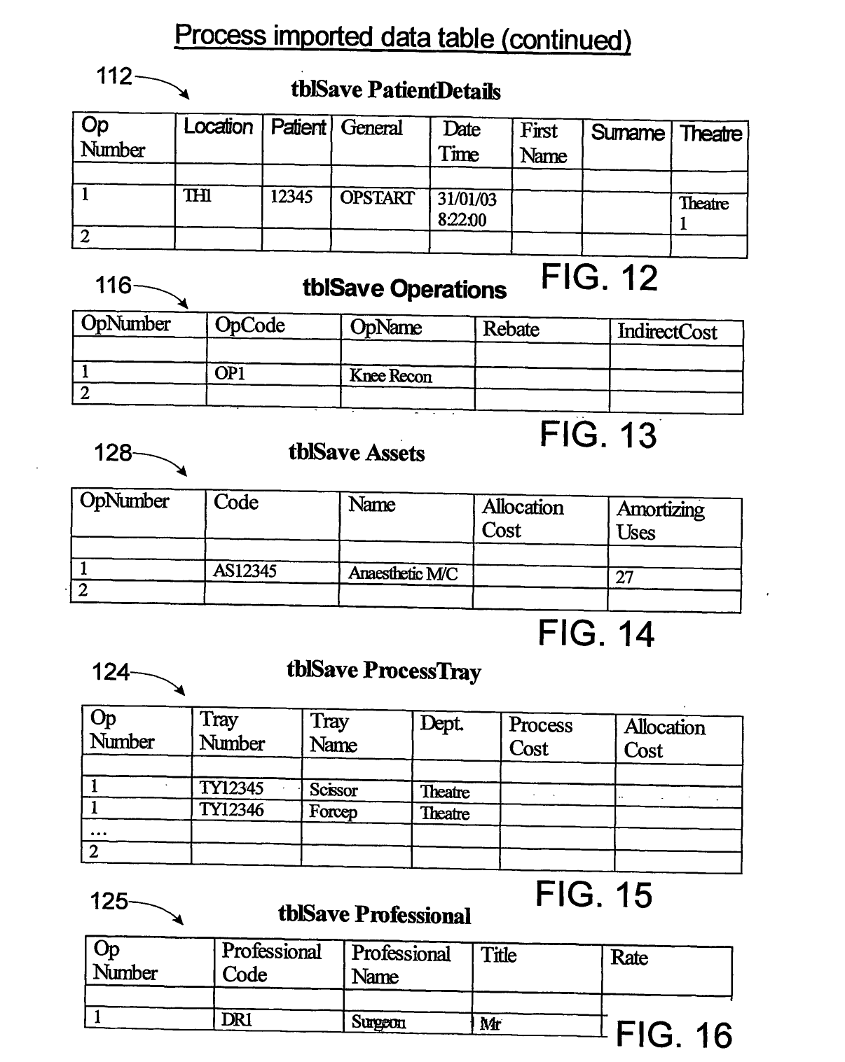

In FIG. 11, reference numeral 106 generally indicates a flowchart of a program used to process the theatre datastring, the patient datastring, the operation datastring and miscellaneous datastrings of the imported data table 102. Thus, a first module 108 of the program looks up the theatre datastring to retrieve “TH1=Theatre 1” and writes the result to relevant save tables. A second module 110 looks up the patient datastring to retrieve “12345=Patient Name” and writes the result to a save table 112 in FIG. 12. A third module 114 looks up the operation datastring, obtains medical fund rebate details and indirect costs from the administrative database 30 and writes the operation datastring and the further data to a save table 116 shown in FIG. 13.

Also in FIG. 11, reference numeral 118 generally indicates a fourth module of the program for processing the data in the column 96.4.

The module 118 begins by querying whether any datastring that is stored in the column 96.4 has a prefix “AS”, which indicates that the string following the prefix relates to an asset.

If the query returns a positive, the module 118 uses the datastring to look up that particular asset code from the asset code directory 52 in FIG. 1. This returns the result “AS12345=Anaesthetic M/C”, for example. The module 118 then adjusts a usage count and an amortization amount in the inventory directory 36 before moving to a subsequent step.

If the query returns a negative, the module 118 jumps to the subsequent step. In this step, the module 118 queries whether any datastring that appears in the column 96.4 of the table 102 has a prefix “S”, which would indicate that the string following the prefix would relate to a staff member code.

If the query returns a positive, the module 118 uses the datastring to look up that particular staff member code in the staff code directory 48 of FIG. 1. As can be seen in FIG. 11, this returns a result “S1=Staff Member 1′. The module 118 then retrieves the hourly rate, the title and the department of staff member 1 from the staff directory 38. The program then moves to a subsequent step.

If the module 118 returns a negative, the module 118 jumps to the subsequent step. In that step, the module 118 queries whether any datastring that appears in the column 96.4 of the table 102 has a prefix “PR”, which would indicate that the string following the prefix would relate to a prosthetic code.

If the query returns a positive, the module 118 looks up that particular prosthetic code in the asset code directory 52 of FIG. 1. As can be seen in FIG. 11, this returns a result “PR1=Knee Bit”. The module 118 then retrieves the price and updates the patient number associated with the prosthetic PR1 in the inventory directory 36. The module 118 then moves to a subsequent step.

If the query returns a negative, the module 118 jumps to the subsequent step. In that step, the module 118 queries whether any datastring that appears in the column 96.4 has a prefix “TY”, which would indicate that the string following the prefix relates to a process tray code, which is a code representing a tray of surgical instruments as described below.

If the query returns a positive, the module 118 looks up that particular process tray code in the table 76 and returns the result “TY12345=Scissor”, for example. The module 118 then retrieves the process and allocation costs associated with that process tray from the directory 52.

If the query returns a negative, the module 118 loops to a subsequent step. In this step, the module 118 queries whether any datastring that appears in the column 96.4 is without a prefix.

If the query returns a positive, the module 118 performs a look up operation on the product code directory 54 and returns the result “12345=Basic Pack”, for example. As set out above, products such as consumables do not have a prefix. The module 118 then retrieves the price of that product and adjusts a stock number in the consumables directory 32.

If the query returns a negative, the module 118 jumps to the subsequent step. In that step, the module 118 queries whether any datastring that appears in the column 96.4 of the table 102 has a prefix “DR”, which would indicate that the string following the prefix would relate to a professional code.

If the query returns a positive, the module 118 looks up that particular professional code in the professional directory 46 of FIG. 1. As can be seen in FIG. 11, this returns a result “DR1=(name)”. The module 118 then retrieves the title and charge rate of that professional.

If the query returns a negative, the module 118 loops to a subsequent step. In that step, the module 118 queries whether any datastring that appears in the column 96.4 is “OPSTART”, which represents the date and time the procedure was started.

If the query returns a positive, the module 118 performs a look up operation on the miscellaneous table 68 and returns the result “OPSTART=08:22:00, 31.01.03”, for example.

If the query returns a negative, the module 118 loops to a subsequent step. In this step, the module 118 queries whether any datastring that appears in the column 96.4 is “OPFINISH”, which represents the date and time the procedure was finished.

If the query returns a positive, the module 118 performs a look up operation on the table 68 and returns the result “OPFINISH=08:45:23, 31.01.03”, for example.

If the query returns a negative, the module 118 writes the retrieved datastrings and other data to the save tables shown in FIGS. 12 to 19. It will readily be apparent that each of the save tables has a column labelled OpNumber. This column contains the activity codes described above. Thus, in each of the save tables, a particular activity code associates all elements in a particular row.

In FIG. 12, reference numeral 112 indicates a save table in which patient details generated by the program described with reference to FIG. 11 are saved. As can be seen in FIG. 12, the save table 112 stores the activity code “1”, the location, the patient code, general codes, a date and time, a first name, a surname and theatre details. Thus, in the save table 112, activity code “1” is associated with location “TH1”, patient no. “12345”, a start time of 31/01/03-08:22:00, a first name of the patient, a surname of the patient and theatre no. 1. In the same table, activity code “2” can be associated with a number of other elements completely unrelated to the elements associated with activity code “1”.

In FIG. 13, reference numeral 116 indicates a save table in which operation details generated by the program described above are saved. As can be seen in FIG. 13, the save table 116 stores the activity code “1”, an operation code, an operation name, rebate details and indirect cost details. These details are retrieved as a result of the program represented in FIG. 11. As above, activity code “2” can be associated with unrelated elements in the same save table 116.

In FIG. 14, reference numeral 128 indicates a save table in which asset details generated by the program represented in FIG. 11 are shown. As can be seen in FIG. 14, the save table 128 stores the activity code “1”, the asset code, the asset name, the allocation cost and a number used for amortizing purposes.

In FIG. 15, reference numeral 124 generally indicates a save table to which instrument details, in particular, details relating to trays associated with particular instruments are written by the program described with reference to FIG. 11.

The table 124 stores, in columns, the activity code “1”, a tray number, a tray name, a department, a cost of processing the trays and a cost of allocating the tray.

In FIG. 16, reference numeral 125 generally indicates a save table to which professional details generated by the program of FIG. 11 are described. The table 125 stores, in columns, the activity code, the professional code, the professional name, the title of the professional and the rate charged by the professional.

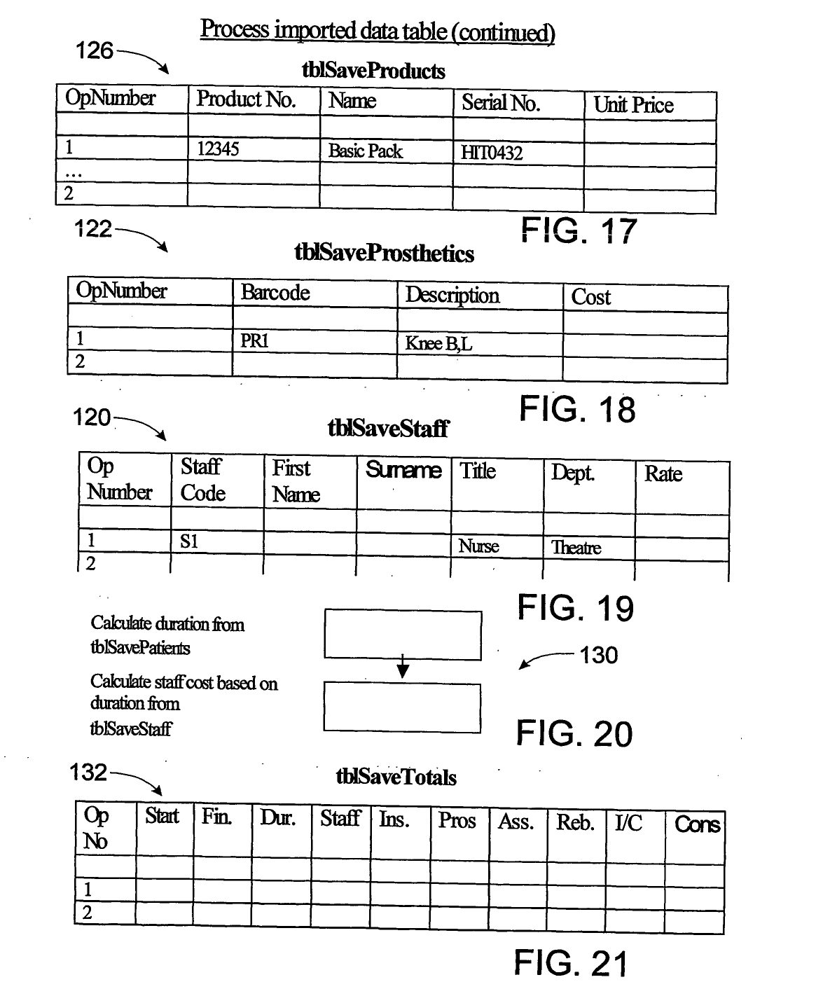

In FIG. 17, reference numeral 126 generally indicates a save table to which product or consumable details are written by the program described with reference to FIG. 11.

The table 126 stores, in rows, the activity code “1”, a product number, a product name, a serial number of the product and a unit price of the product.

In FIG. 18, reference numeral 122 generally indicates a save table to which prosthetic details are written by the program described with reference to FIG. 11. The table 122 stores, in rows, the activity code “1”, a barcode representing a prosthetic, a description of the prosthetic and a cost of the prosthetic.

In FIG. 19, reference numeral 120 generally indicates a save table to which staff details are written by the program described with reference to FIG. 11. The table 120 stores, in rows, an activity code “1”, a staff code, a first name, a surname, a title, a department and a rate of pay of that particular staff member.

In FIG. 20 there is shown a short flowchart 130 that represents a program for calculating staff costs. The program first calculates a duration of an operation from the save table 112. Then the program calculates the staff cost using the duration value and the staff rate obtained from the save table 120.

The program uses the activity codes “1” and “2” to retrieve the relevant details from the save tables. It will be appreciated that any set of details can be extracted by using the activity codes. Applicant submits that an attempt to describe all possible programs would be tautologous. In short, Applicant submits that the program is capable of generating professional, patient, staff and asset records by a simple application of the activity codes with suitable logarithmic programs to selected sets of save tables generated by the program described in FIG. 11 using data recorded by the scanning process described above.

For example, in FIG. 21, reference numeral 132 generally indicates a save table of a particular set of totals generated using the save tables generated by the program depicted in FIG. 11. In particular, the save table 132 has rows divided into columns that set out, respectively, an operation number, a start time of the operation, a finish time of the operation, a duration of the operation, staff member details, instrument costs, prosthetic costs, asset costs, rebate amounts, I/C costs and consumable costs. All these factors are associated with a particular activity number, in this case, the activity numbers “1” and “2”. This facilitates the retrieval of these amounts from the save tables.

It will readily be appreciated that suitable reports can be generated by extracting the relevant details from the save table 132.

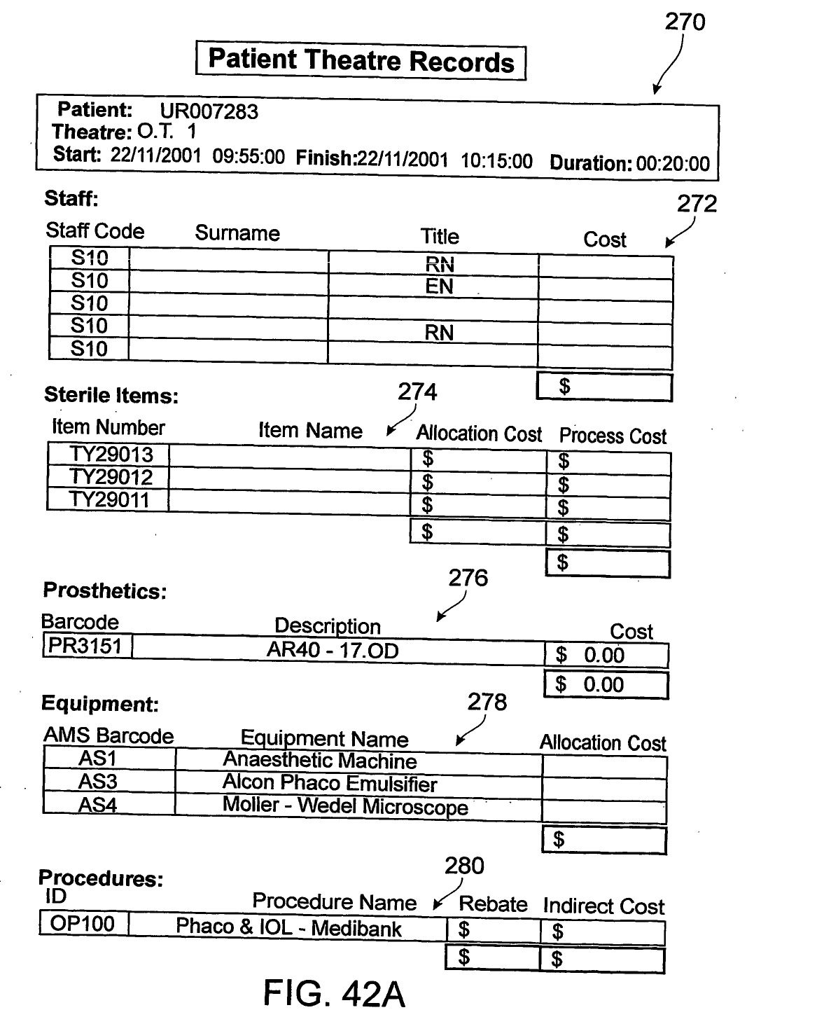

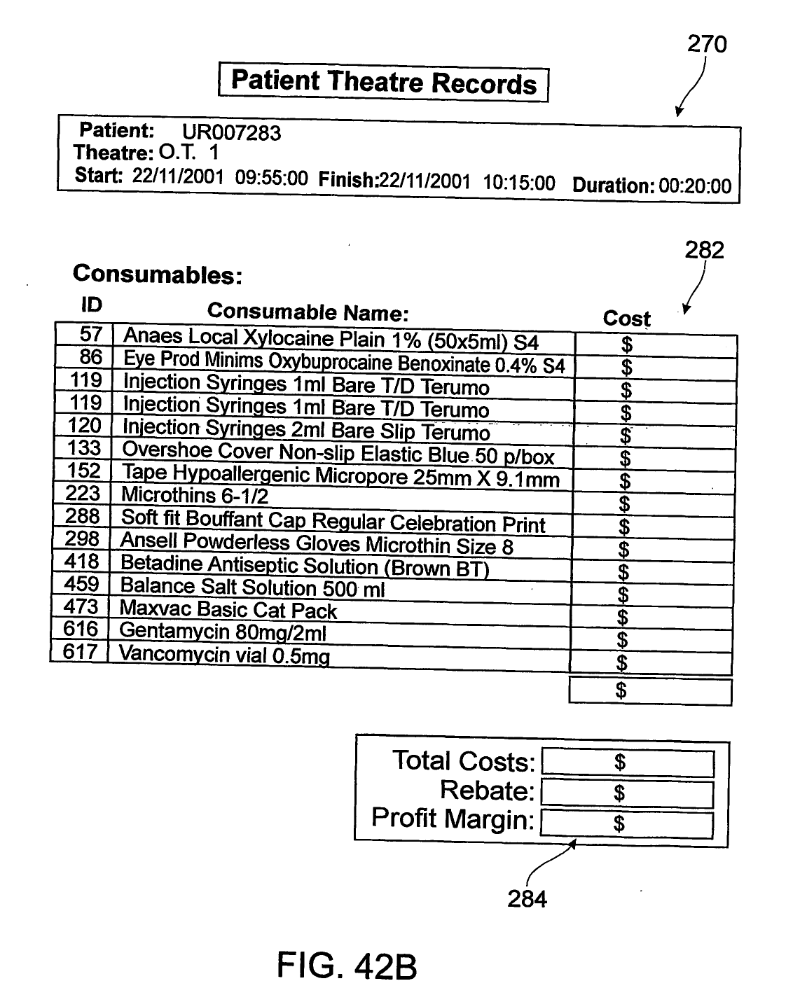

In particular, it will be appreciated that the retrieval of various cost details is facilitated by the generation of the save tables with each row being associated with a particular activity code. By making a simple query, an operator is able to associate any element with a particular activity code. That activity code is then used to obtain details of all costs associated with that element, by making a further simple query. In this manner, records, such as those shown in FIG. 42 can readily be generated.

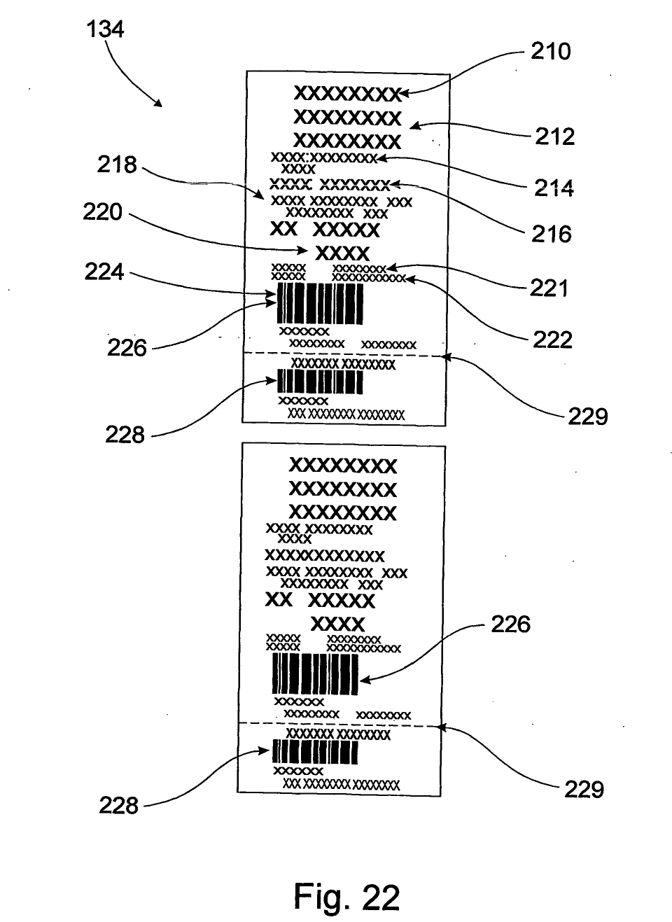

In FIG. 22, reference numeral 134 generally indicates a barcode label that is generated by the secondary computer 20. The label 134 is to be applied to a surgical tray and is generated subsequent to a sterilization process that is described in greater detail below.

The barcode label 134 has an adhesive backing which can be peeled away to allow the label 134 to be adhered to a surgical tray wrapper. The secondary computer 20 is programmed to generate a product identification name 210, a package/item name 212, a name 214 of the hospital to which the item belongs, a relevant department name 216, a storage location name 218, a number 220 of items in the package, a date 221 on which the package was created, a shelf life 222, a package barcode 224, a human readable component 226 of the barcode 224, and a duplicate barcode 228.

The package barcode 224 is separable from the duplicate barcode 226 with a perforation 229. Thus, the duplicate barcode 226 can be adhered to a patient record.

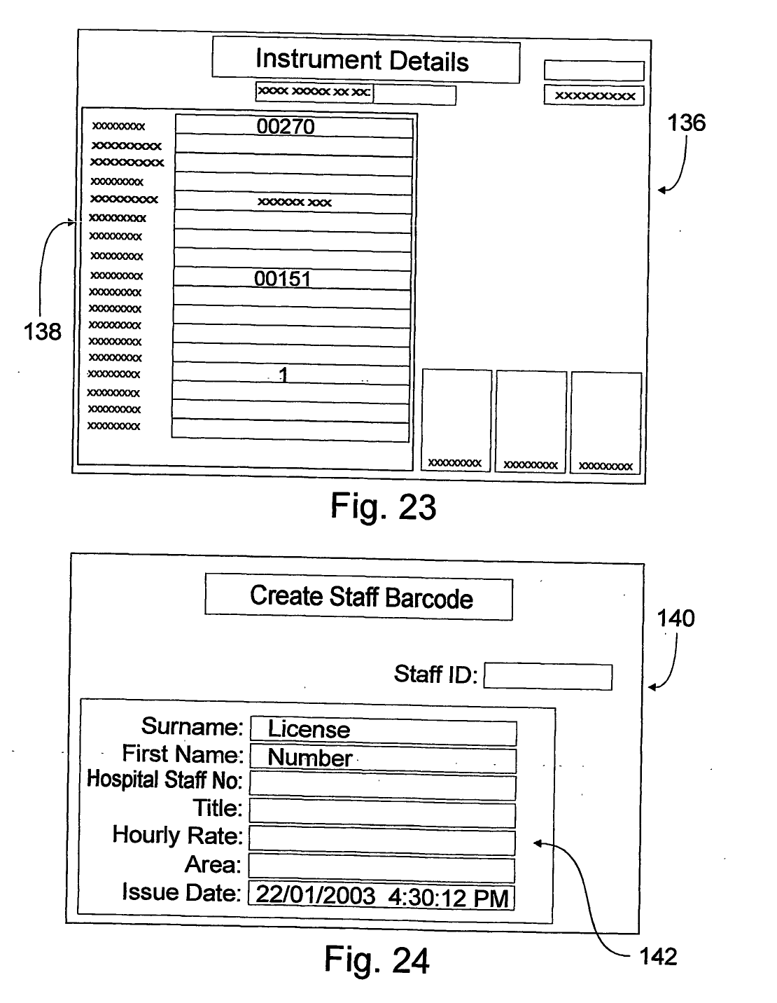

In FIG. 23, reference numeral 136 generally indicates a graphic user interface (GUI) for displaying data relating to a particular instrument.

The GUI 136 includes fields 138 for displaying instrument details, department details associated with the instrument, purchase price, allocation cost, invoice number, warranty, service details, amortizing uses, date last serviced, service status and special instructions. Of importance is the fact that the program of the invention is configured to extract the data for the GUI 136 from the inventory directory 36. Thus, an operator can enter a particular instrument code and the computer 12 is configured to perform a look up operation on the asset code directory 52 to obtain an asset name and to extract details from the inventory directory 36. In particular, the computer 12 is programmed to extract the data for the fields 138 from the save tables generated by the program described with reference to FIG. 11.

In FIG. 24, reference numeral 140 generally indicates a GUI that is used to create a barcode associated with a particular staff member. Thus, the GUI 140 includes fields 142 which are configured to receive surname details, first name details, hospital staff number, title, hourly rate, area and issue date. This data is stored in the administrative database 30 and is associated with a particular barcode that represents an alphanumeric string with a prefix “S”. The alphanumeric string is stored in the staff code directory 48 of FIG. 1. Thus, when the scanner 18 reads the barcode, as set out in FIGS. 3 and 6, the computer 20 is programmed to query the alphanumeric string to determine if the prefix “S” is present. If so, the computer 20 communicates the positive result to the computer 12, which is programmed to query the staff code directory 48 in FIG. 1 to extract the alphanumeric string that identifies the particular staff member. This permits the computer 12 to extract the data entered at the GUI 140 and write it to the save tables as set out above.

It will readily be appreciated that a similar procedure can be used to generate barcodes relating to other workplace elements.

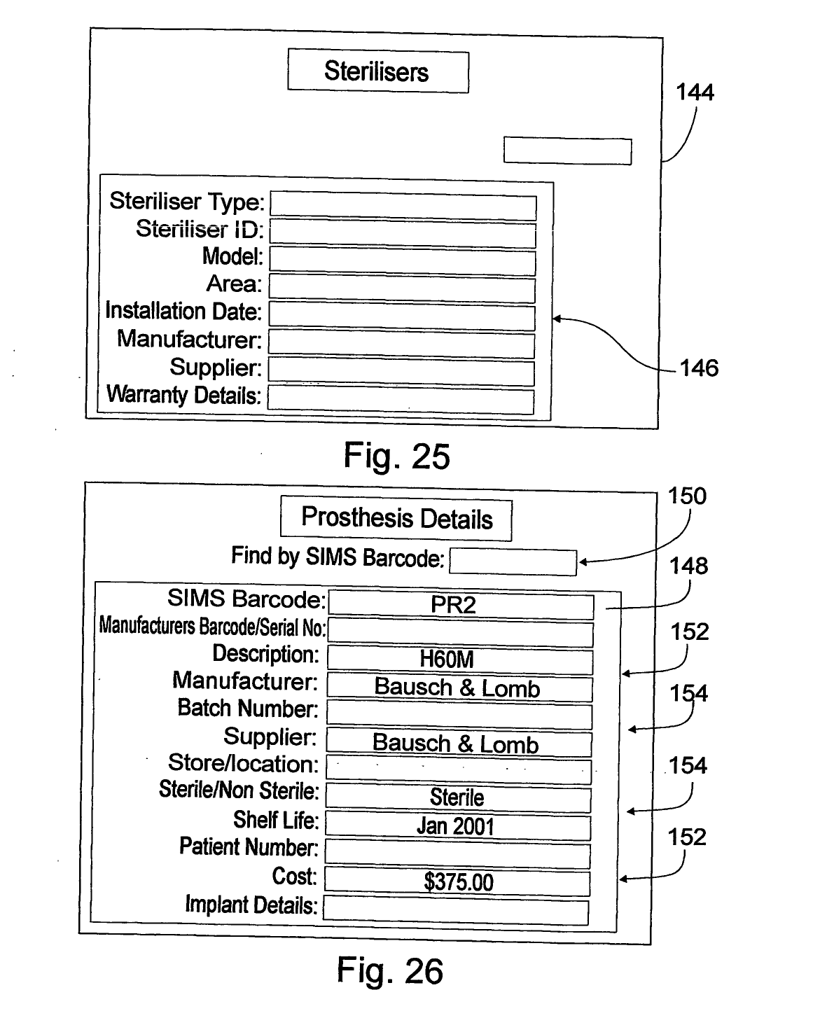

In FIG. 25, reference numeral 144 generally indicates a GUI for allowing an operator to enter details relating to an asset into the inventory directory 36. In this case the asset is in the form of a steriliser. The GUI 144 includes fields 146 to permit an operator to enter details of the steriliser into the inventory directory 36. In particular, the fields 146 define inputs for type, identification, model, area for the asset, installation date, manufacturer, supplier and warranty details. The computer 12 is configured to associate the identification of the steriliser with a particular datastring, which is then written to the asset code directory. This can be done at the computer 20, if necessary, so that the entered data can be communicated to the computer 12 via the network 14.

In FIG. 26, reference numeral 148 generally indicates a GUI for allowing an operator to look up details relating to a prosthetic from the inventory directory 36. The GUI 148 thus includes a datastring input field 150 for allowing the operator to input a datastring that represents the prosthetic. The GUI 148 also includes various other input fields 154 that can be used by the operator to input relevant information to facilitate the look up operation. The computer 12 is programmed to perform a look up operation in the administrative database 30 to generate relevant data that is displayed in display fields 152.

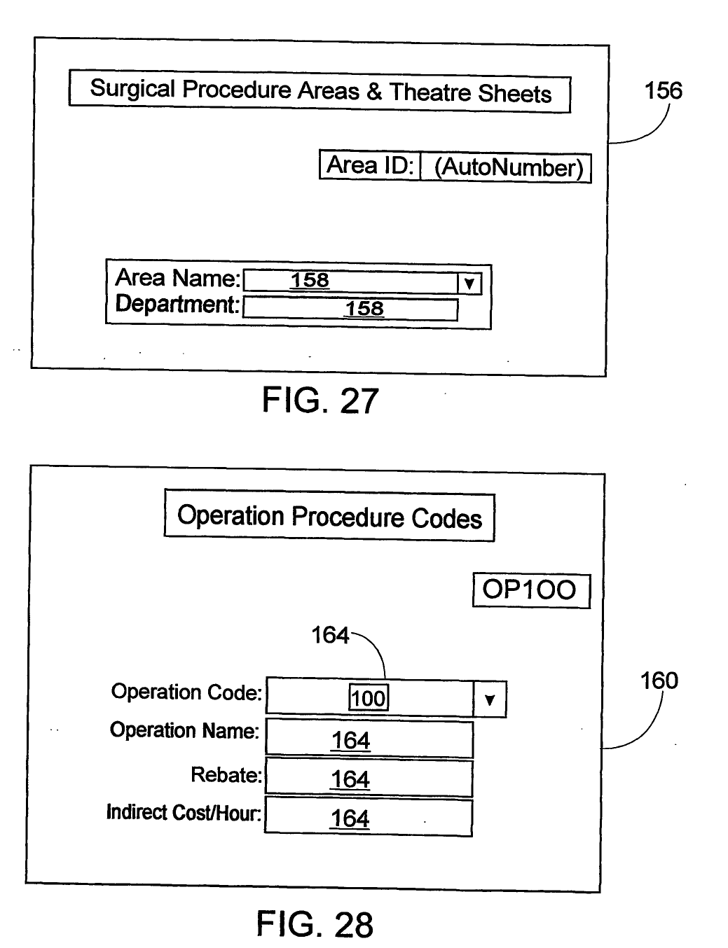

In FIG. 27, reference numeral 156 generally indicates a GUI for allowing the input of information relating to a particular surgical area to the administrative database 30. The GUI 156 includes input fields 158 to permit the input of the name of the area and a department in control of that area. This information is then retrieved when generating the save tables using the program described with reference to FIG. 11.

In FIG. 28, reference numeral 160 generally indicates a GUI for allowing an operator to look up information relating to operation procedure codes. The GUI 160 includes an input field 162 to permit the selection and input of a particular code. The GUI 160 further includes display fields 164 for displaying an operation name, a rebate value and indirect costs per hour associated with that particular operation. The computer 12 is thus programmed to retrieve the displayed information from the administrative database 30 upon the input of the operation code.

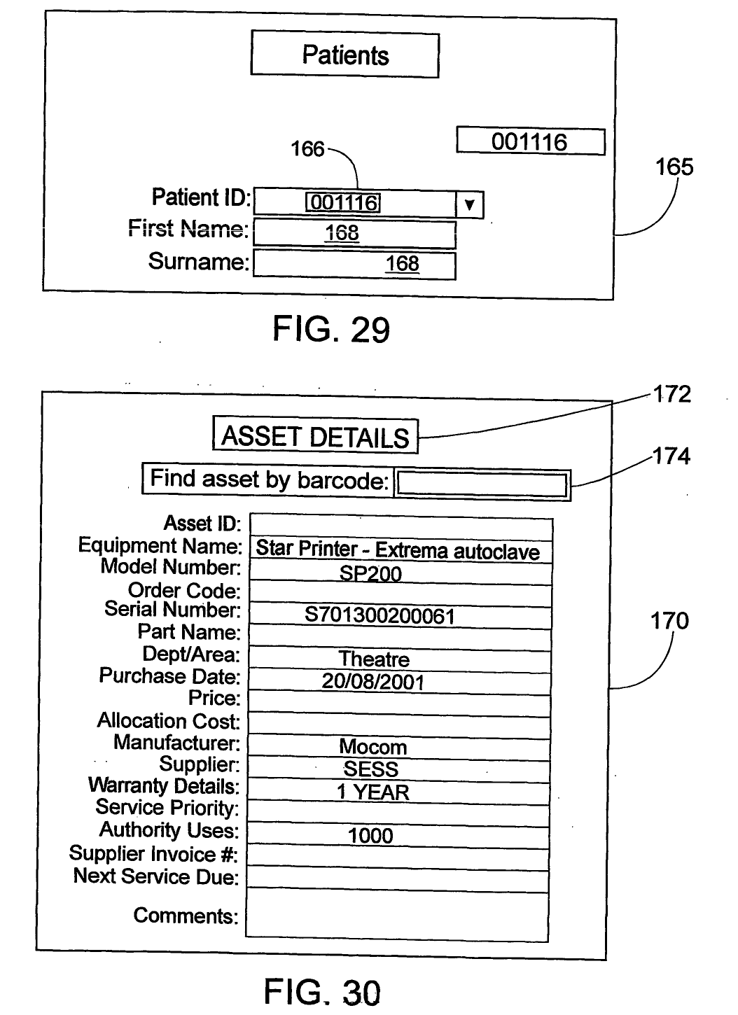

In FIG. 29, reference numeral 165 generally indicates a GUI for allowing an operator to look up information relating to a particular patient. The GUI 165 includes an input field 166 so that the operator can select and input a particular code. The GUI 165 further includes display fields 168 for displaying a patient's first name and surname. The computer 12 is thus programmed to retrieve this information from the administrative database 30 upon the input of the patient code.

In FIG. 30, reference numeral 170 generally indicates a GUI for allowing an operator to look up information relating to a particular asset. The GUI 170 includes a code input field 172 to allow the operator to select and input a particular asset code. This asset code can be obtained for example from the human-readable component 226 of the barcode label described above. The GUI 170 includes a number of display fields 174 for displaying information relating to the asset.

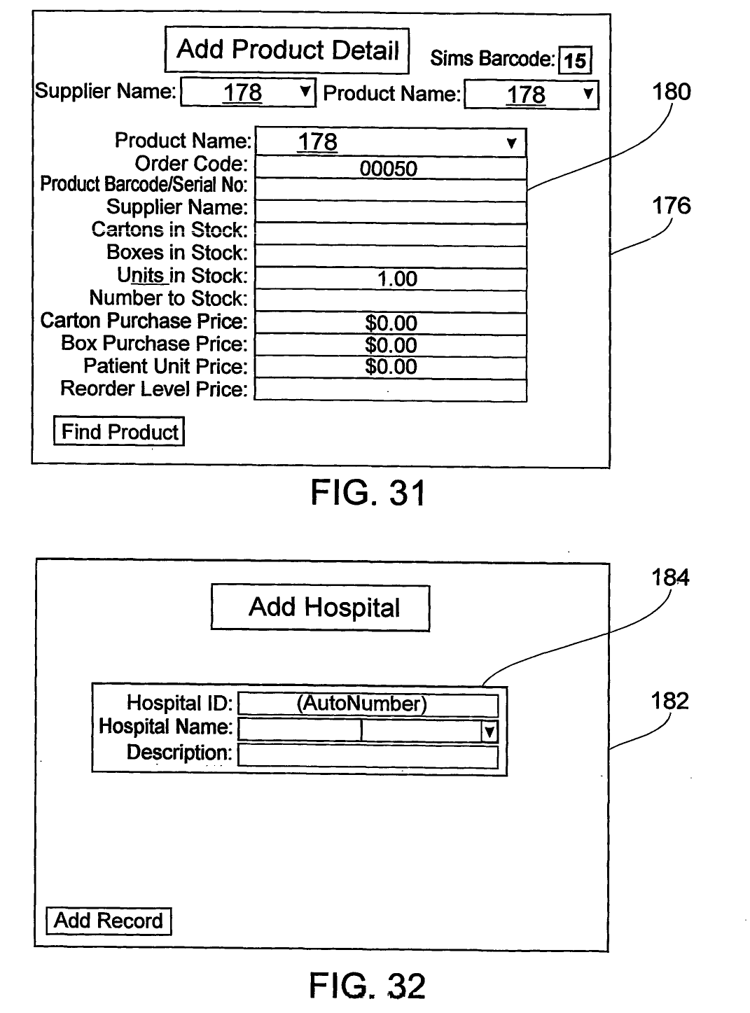

In FIG. 31, reference numeral 176 generally indicates a GUI for allowing an operator to add details of a product acquired by the hospital. In this case, the computer 20 generates the GUI 176 so that the information can be communicated to the computer 12 via the network 14. The GUI 176 has input fields 178 for entering a supplier name, a product name, an order code, a product serial number, a number to order, purchase prices, a unit price per patient and a level at which more of the product should be ordered. The GUI 176 also has display fields 180 for displaying quantity in stock. Thus, the computer 12 is programmed to write the input data to the administrative database 30 to update the database 30. The computer 12 is also programmed to retrieve the data for the display fields 180 and to communicate that data to the computer 20, via the network 14.

In FIG. 32, reference numeral 182 generally indicates a GUI for allowing a user to input data relating to a hospital to be added to the apparatus 10. Thus, the GUI 182 includes input fields 184 for inputting a hospital ID, a hospital name and a hospital description to the administrative database 30.

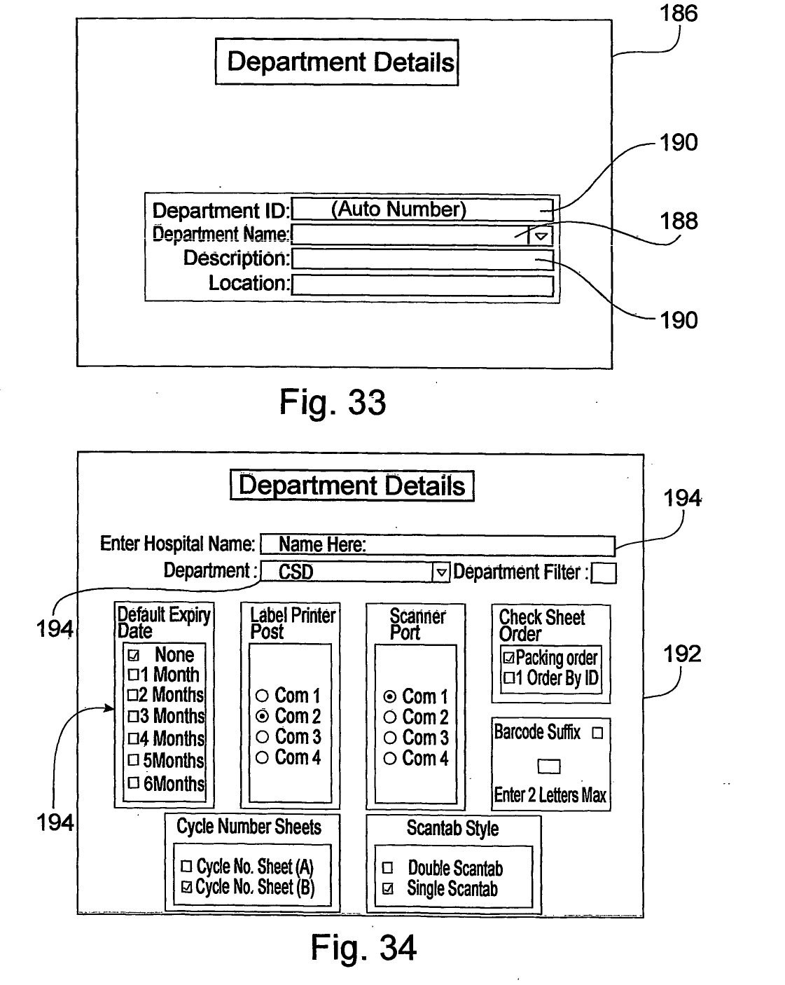

In FIG. 33, reference numeral 186 generally indicates a GUI for allowing an operator to input data relating to a department of a hospital to the administrative database 30. Thus, the GUI 186 includes input fields 188 for inputting a department name, a department description and a department location. The GUI 186 also includes a display field 190 for displaying an automatically generated department datastring. Thus, the computer 12 is programmed to write the input data to the database 30 and to generate a datastring that is associated with that department. The datastring is written to the registration database 28 by the computer 12.

In FIG. 34, reference numeral 192 generally indicates a GUI for allowing an operator to set up a barcode printer and scanner operation. The GUI 192 has input fields 194 for inputting a hospital name, a department name, an expiry date for the product for which a barcode is intended, a port from which the barcode is to be printed, a port to which the scanner 18 is to be connected, a check sheet order selection, a barcode suffix, a sheet cycle type and a scan style.

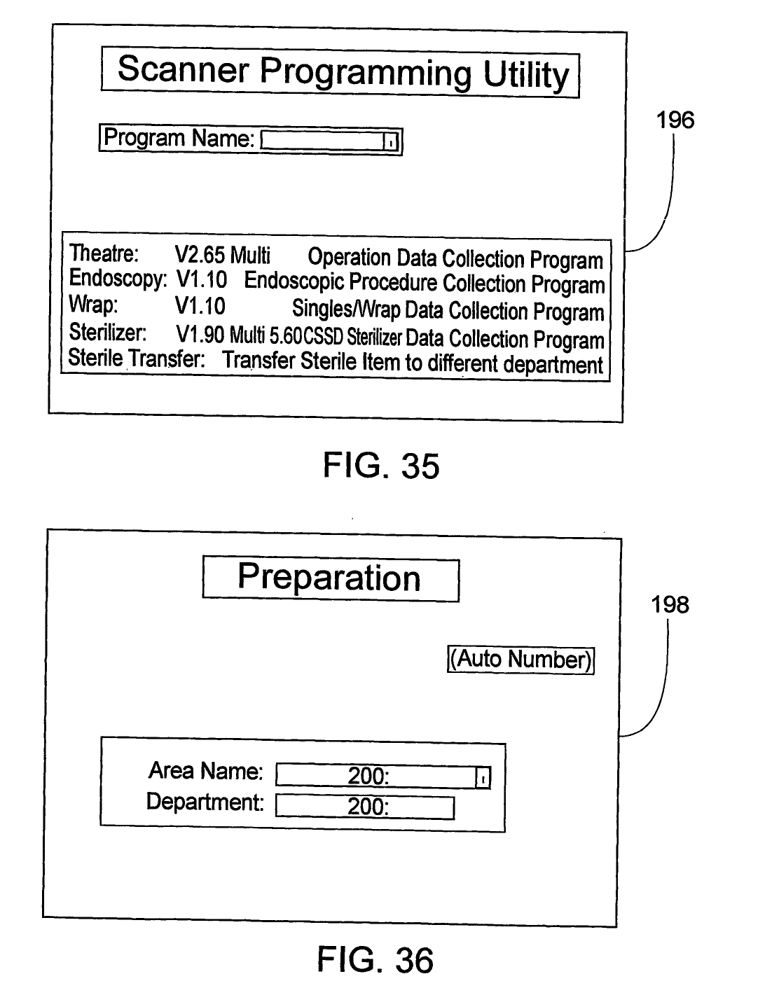

In FIG. 35, reference numeral 196 indicates, schematically, one of the scanners 18. As can be seen, the scanner 18 is programmed to permit the selection of any of a number of procedures to which the scanner 18 is to be applied.

In FIG. 36, reference numeral 198 generally indicates a GUI for allowing an operator to input preparation area details to the administrative database 30. The GUI 198 thus includes input fields 200 for inputting an area name and a department name. The computer 12 is thus programmed to write this data to the administrative database 30. The computer 12 is also programmed to generate a datastring that represents the preparation area and to write the datastring to the registration database 28.

As set out earlier, each procedure is associated with a particular group of workplace elements. The reason for this is that the management of workplace elements is greatly facilitated. For example, a particular medical professional can be associated with a particular procedure or procedures. Each of these procedures is then allocated a particular group number. Thus, each group number can be associated with a particular set or group of workplace elements. It follows that it can readily be assumed that whenever a particular procedure is carried out by a particular medical professional, a certain group of workplace elements are processed.

In most workplaces, the professional is responsible for the entire procedure that takes place on a patient. It follows that the professional usually has a consistent set of workplace elements which are associated with a particular procedure. These include inventory, medical devices and also staff that assist the professional. Accordingly, these workplace elements can be allocated a particular group which will be recorded each time the professional carries out a particular procedure.

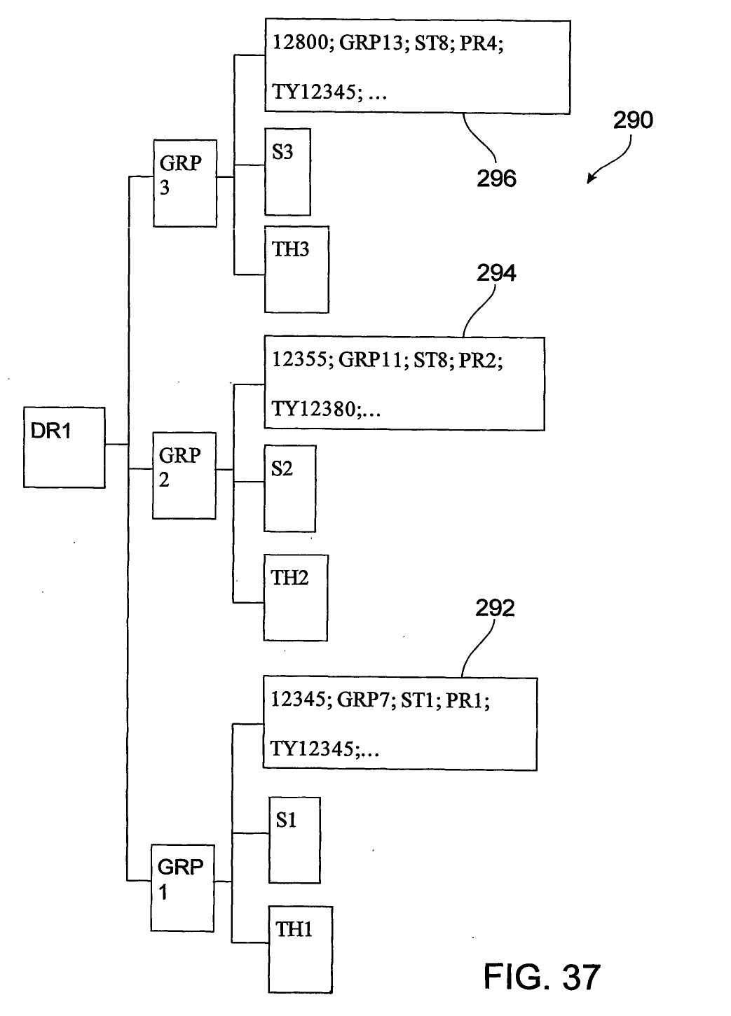

It follows that the computer 12 is programmed so that each group code in the directory 56 is associated with a particular professional in the directory 46. An example of such a database structure is shown in FIG. 37 and indicated generally with reference numeral 290.

In the structure 290, a code DR1, which represents a professional, is associated with three groups GRP1, GRP2 and GRP3. It is to be appreciated that, in reality, the code DR1 will be associated with a larger number of groups, since each group represents a set of workplace elements associated with a particular procedure. The three are chosen for the sake of simplicity. It follows that when one of the groups GRP1-3, is recorded by scanning an appropriate barcode, the code DR1 is automatically recorded.

As can be seen in FIG. 35, each of the groups is associated with two closed fields, TH1-3 and S1-3. These codes represent staff and theatres that are consistently used with particular procedures. Each of the groups is also associated with an open field 292, 294, 296. Each open field 292 to 296 contains codes relating to various workplace elements, as described in greater detail below.

It is important to note that the open fields 292 to 296 each also contain codes representing further groups. This allows for a situation where procedures contain sub-procedures which are associated with sets of workplace elements.

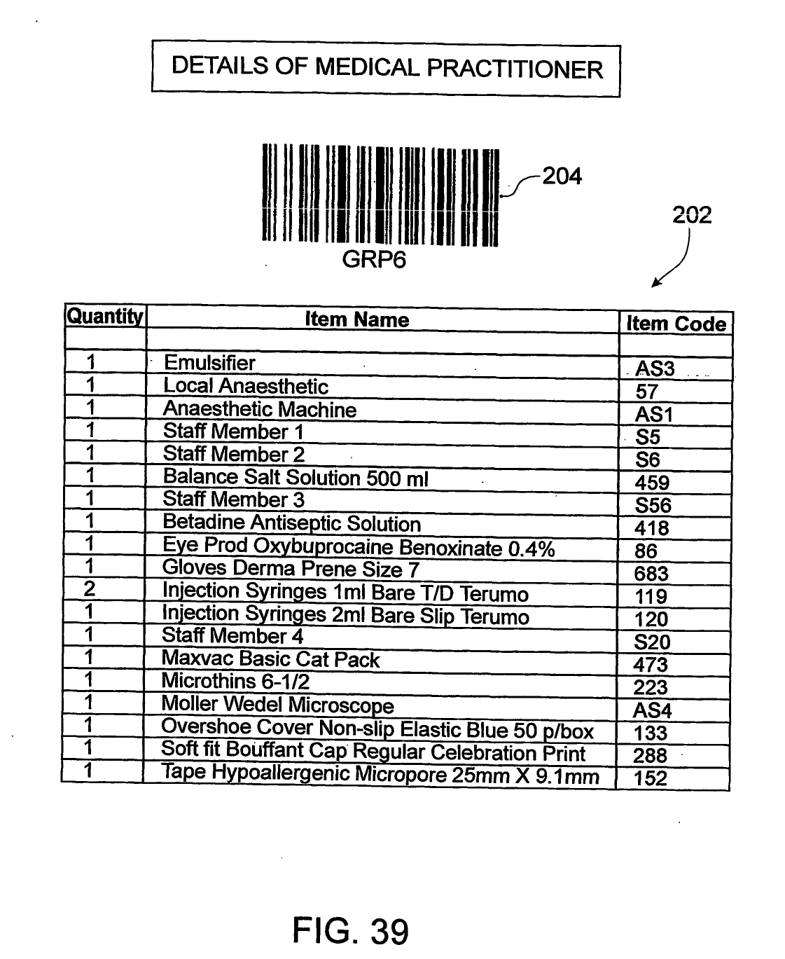

In FIG. 39, reference numeral 202 generally indicates a printout, generated by the computer 12 of details of a group, in this case GRP6 that corresponds with a barcode 204. As can be seen in FIG. 37, there is set out a table that has a “quantity” column, an “item name” column and an “item code” column. The workplace elements set out in the table are those that are used when the medical professional associated with GRP6 carries out a procedure.

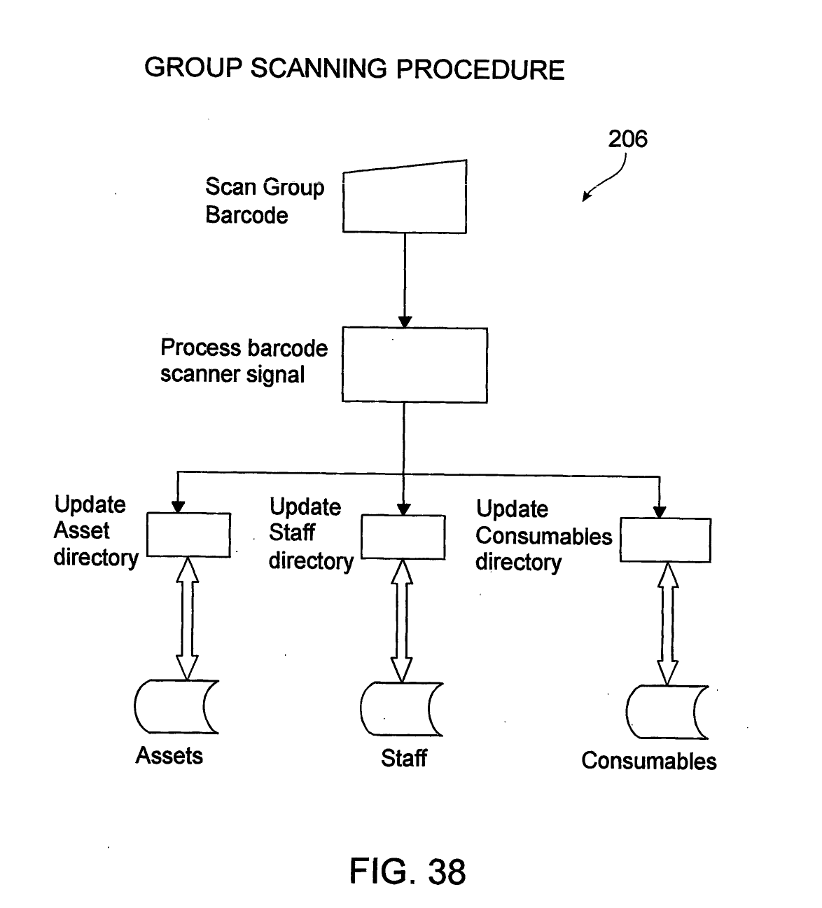

In FIG. 38, reference numeral 206 generally indicates a manner in which the computer 12 is programmed to use group codes. At the start of the procedure, the barcode 204 is scanned. The resultant signal is processed to generate the datastring “GRP6”. The computer 12 is programmed to update the asset directory, the staff directory and the consumables directory, in the manner described above. It will also be appreciated that details of the professional associated with GRP6 are retrieved.

It follows, therefore, that it is not necessary for each of the workplace elements listed in FIG. 39 to be scanned every time the procedure associated with GRP6 is carried out.

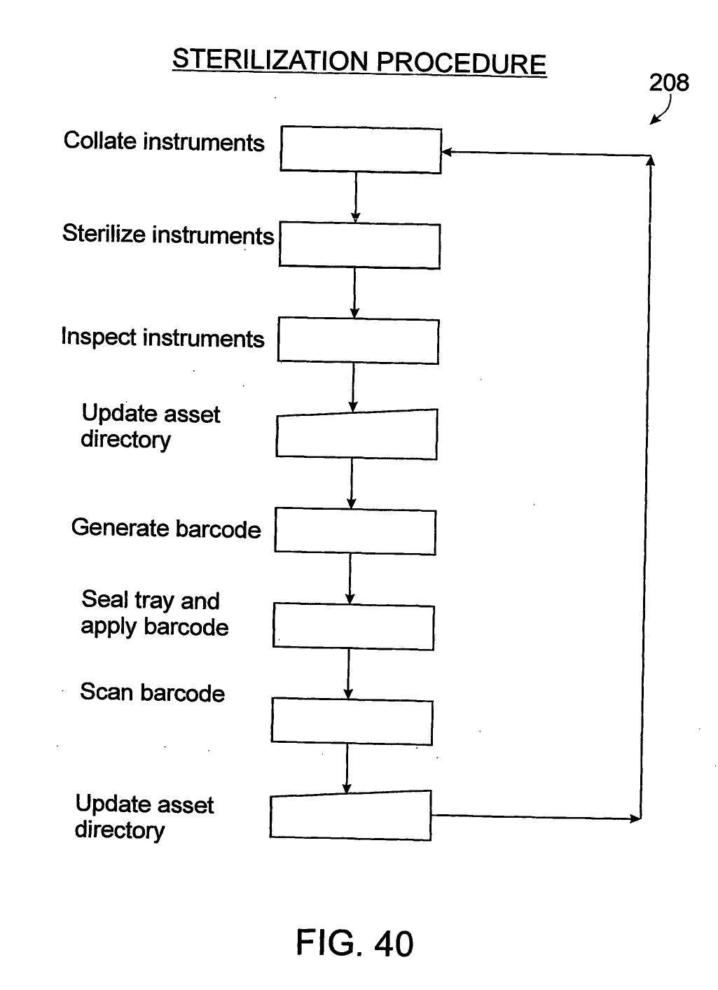

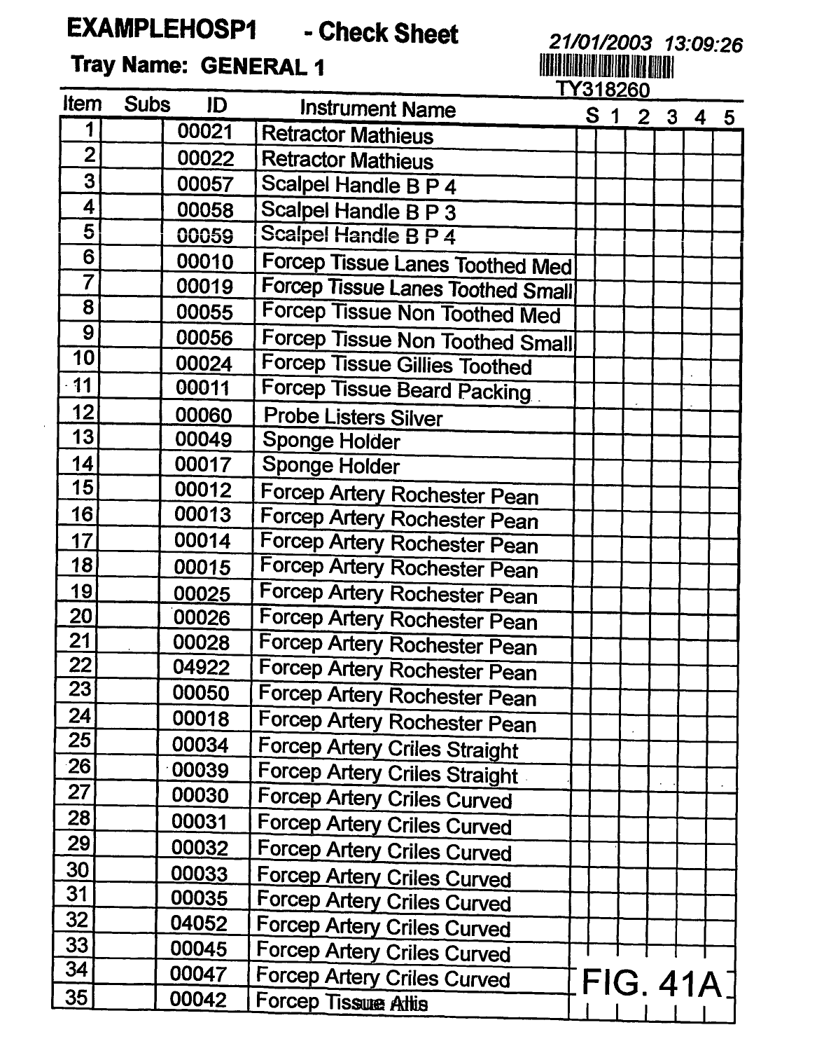

In FIG. 40, reference numeral 208 generally indicates a sterilization procedure that is carried out in accordance with a method of the invention.

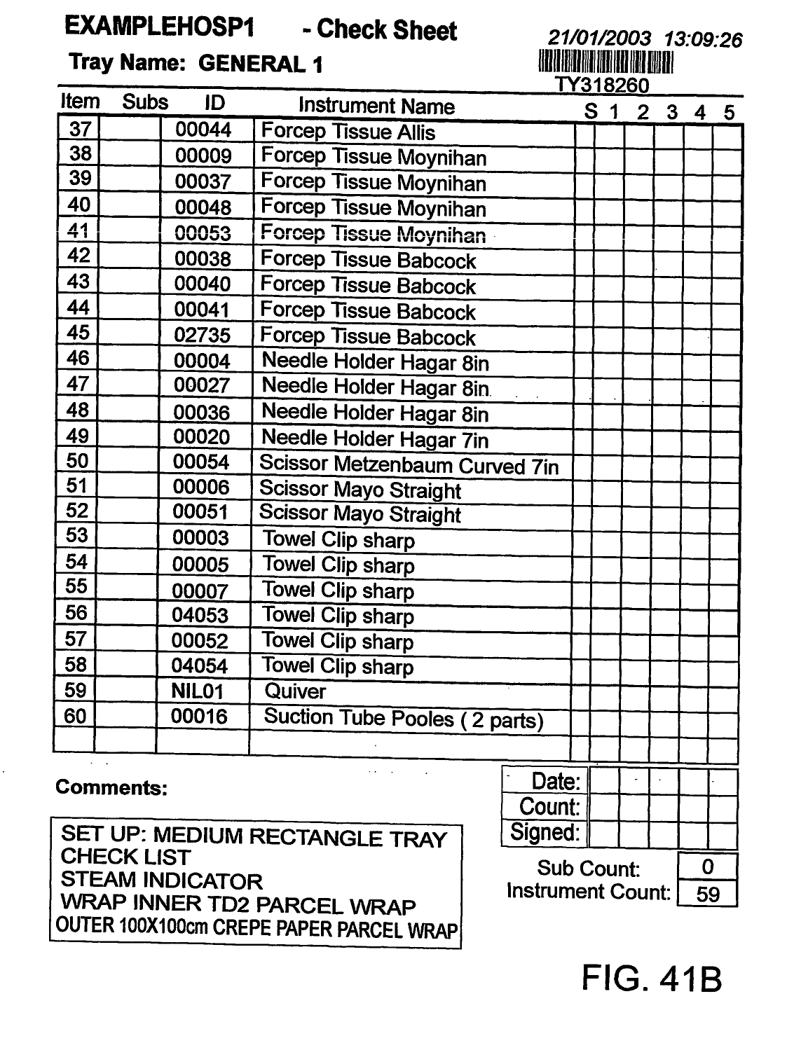

As is known, surgical instruments are usually collated in particular trays. It follows that each tray in an operating theatre holds a predetermined number and type of surgical instruments. In FIG. 41, there is set out a list of surgical instruments that are associated with a particular tray that is referenced with a datastring “TY318260”. The reason for the prefix “TY” is set out above. The numeric string following does not have any significance apart from the fact that it is associated with that particular tray.

Referring to FIG. 40, once the instruments of that tray are ready for sterilization, the instruments are collated onto the tray and conveyed to a sterilization area. The instruments are then sterilized. Once sterilized, the instruments are inspected for defects and replaced if necessary.

As can be seen in FIG. 41, the check sheet, which is generated by the computer 12, has an item number column, a substitution column, an identification column, a description column and a number of other checking columns.

The check sheet is presented in a suitable interface to the operator at the sterilization area so that, if one of the instruments is replaced, the operator can enter the ID number of the new instrument in the substitution column.

In this way, the inventory directory 36 is updated to record even the replacement of a single instrument in a tray.

The tray is then packed and wrapped in a suitable sealing material. The computer 12 is configured so that, once the tray is wrapped, the operator can use the computer 12, via the interface, to generate a datastring (TY318260). The interface includes a conventional barcode printer so that the operator can print a barcode corresponding to the datastring. This barcode is then applied to the wrapped tray, which is returned to the operating theatre. As set out above, the barcode label 134 is applied to the wrapped tray.

Prior to unwrapping the tray, the barcode 224 is scanned and the resultant datastring is processed in the manner described above. The duplicate barcode 228 is attached to the patient sheet. It will thus be appreciated that the patient can readily be associated with the particular tray used during the operation on the patient.

In FIG. 42, there is shown an example of a patient theatre record that is generated by the computer 12 that is programmed in the manner described above.

The patient theatre record is an example of how the activity codes can be used to retrieve cost and thus profit/loss data relating to particular activities. The various components of the theatre record contain data that has clearly been extracted from the save tables described with reference to FIGS. 12 to 19. For example, details in a patient component 270 are retrieved, using the relevant activity codes from the save table 112. Details in a staff component 272 are retrieved, using the relevant activity codes, from the save table 120. Similarly, details in a sterile items component 274 are retrieved from the save table 124. Details in a prosthetics component 276 are retrieved from the save table 122. Details in an equipment component 278 are retrieved from a save table (not shown). Details in a procedure component 280 are retrieved from the save table 116. Details in a consumables component 282 are retrieved from the save table 126. It will be appreciated that details of the relevant professional and his or her charges can also be retrieved, by using the relevant activity codes in the save table 125.

As can be seen, the use of the activity codes and the save tables allows the costs of each element of the various components to be set out in the patient record. Offsets such as allocation costs and rebate, which are contained in the save tables can also be written to the theatre record to generate an accurate profit margin amount indicated at 284.

In this invention, it is important to note that the generation of the save tables that carry activity codes allows a computer to be programmed to retrieve any set of details from the save tables by using the activity codes as data mining tools. Thus, the computer so programmed provides an operator with a convenient manner of extracting any desired record, simply by writing data from selected save tables into further save tables from which the data can be written into suitable report format.

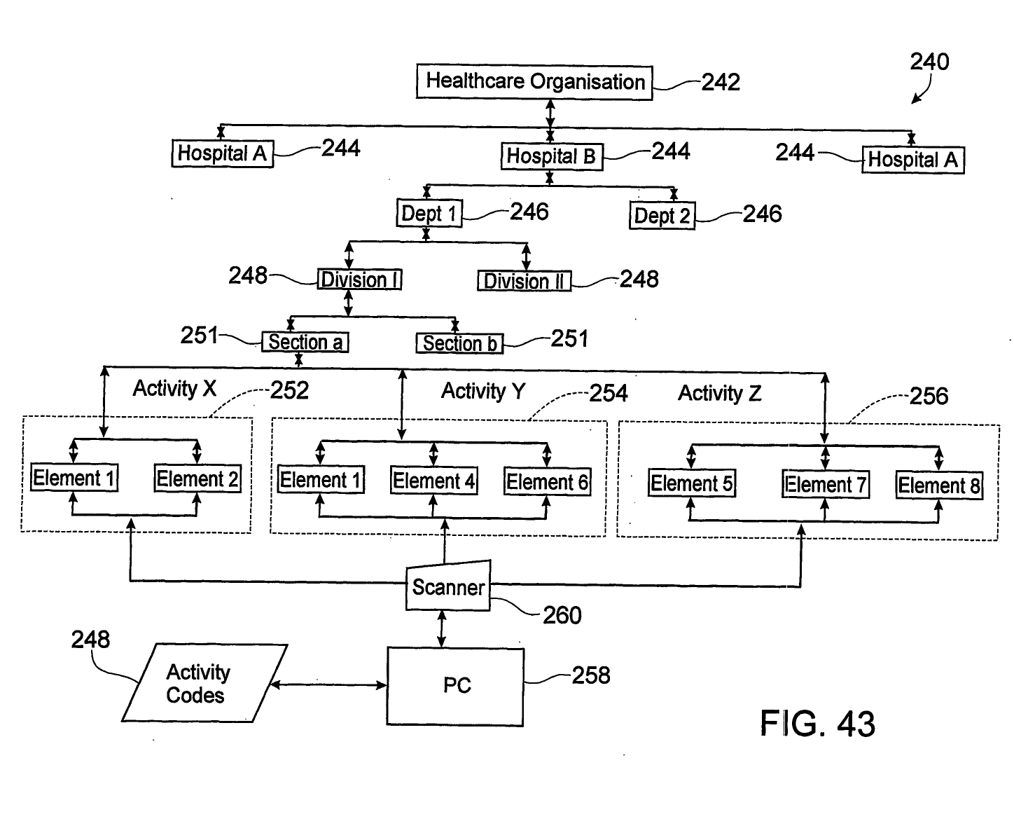

It is a particular advantage of this invention that the activity codes allow the mining of relevant data through various hierarchical layers. In FIG. 43, reference numeral 240 generally indicates an organigram that illustrates an application of the invention.

A healthcare organisation 242 is positioned at the top of the organigram 240. The healthcare organisation 242 can be in the form of a private organisation, a state or federal organisation or any other form of administrative body that controls a number of hospitals, indicated at 244. Each hospital 244 has a number of departments, two of which are indicated at 246. Each department 246 has a number of divisions, two of which are indicated at 248. Each division 248 has a number of sections, a section “a” indicated at 250 and a section “b” indicated at 251.

In practice, each section 250, 251 will control a number of activities that are carried out during the existence of section 250. It will be appreciated that there could be many thousands of activities carried out during the existence of section 250. For example section “a” 250 could control activity X indicated at 252, activity Y indicated at 254 and activity Z indicated at 256. It is to be noted that these are not generic activities, but rather discrete, real-time activities.

During each of the activities, a number of workplace elements are used. As set out in the preamble, each element can be a member of staff, a tray of surgical instruments, an item of equipment, etc. In this case, elements 1 and 2 are used during activity X, elements 1, 4 and 6 are used during activity Y and elements 5, 7 and 9 are used during activity Z. The labels given to the elements are for the sake of convenience only.

As described earlier, the use of each element is recorded by scanning the element at the time of its use. The manner in which the information in connection with each element is recorded has already been described.

The organigram 240 indicates a computer 258. The computer 258 could be the secondary computer 20. The computer 258 is connected to a scanner 260 that is used at the section “a” 250 to scan all the elements used during each activity at the section “a” 250.

The computer 258 is programmed so that, once all the datastrings have been downloaded to the computer 258, from each respective activity, as described above, a unique activity code is allocated from the directory 57 to each respective activity. Thus, each of the unique activity codes can be associated with a set of datastrings that represent the elements used with the respective activities.

Further, as described above, the datastrings of each element provide an indication of their origin by the prefixes incorporated with the datastrings. It follows that simple algorithms can be used by the computer 258 to mine information through the hierarchical system shown with the organigram 240.

In conclusion, the Applicant submits that the present invention provides a means whereby detailed information concerning all activities in a healthcare organisation can be obtained efficiently and quickly. Furthermore, the invention provides a means whereby complex and detailed reports of all aspects of hospital administration can be compiled. This allows administrators to track and control all the activities that take place within a hospital. This is critically important as it allows administrators to put procedures in place that will greatly reduce the risk to patients and therefore reduce the need for costly insurance against liability claims. The primary reason for this is that the procedures can be monitored at any time in a real-time manner or at intervals by generating periodical reports.

A particular advantage of the present invention is that it allows the generation of profit/loss amounts for each activity associated with a particular patient. At present, each patient is generally processed to generate a cost of the whole procedure that is carried out on the patient. In other words, the procedure associated with a particular patient is not broken up into its various activities which are then analysed separately, as is facilitated by this invention. This invention allows a profit/loss evaluation of each activity within an episode of care during a patient's stay at a hospital. This allows profitability to be analysed within the individual activities performed during the patient's stay. It will be appreciated that this provides a means of isolating and improving various activities within a total procedure. This helps to avoid unnecessary rationalization of administrative processes by focussing on the source of perceived problems.

Furthermore, the fact that all the information is made available at the primary computer 12 greatly facilitates a management accounting process that can readily be outsourced to third parties.

Still further, over a period of time, the data generated can be used to improve greatly statistical and performance evaluations of various aspects of healthcare.

1. A method of processing data for the administration of an organisation, the method including the steps of:
generating element data representing details of workplace elements;
recording activity data associated with the workplace elements by recording the element data during workplace activities associated with the workplace elements;
writing the element data and the activity data to a database stored in a data storage device;
associating activity codes with the element data and the activity data;
retrieving the element data and the activity data from the database using the activity codes as keys for such retrieval;
and applying predetermined algorithms to the element data and the activity data to generate reports relating to workplace activities associated with the workplace elements.

2. A method as claimed in claim 1, in which the step of generating element data includes the step of building a registration database that includes at least one look up table that stores element codes and the element data such that each element code represents a predetermined component of the element data associated with that element code.

3. A method as claimed in claim 2, in which the step of generating element data includes the step of converting each element code in the registration database into a barcode and applying the barcode to respective workplace elements, the step of recording the element data including the step of scanning the barcodes.

4. A method as claimed in claim 3, in which the step of writing the element data and the activity data to a database includes the step of writing the element codes to intermediate files together with defining parameters, such that each activity is associated with an intermediate file.

5. A method as claimed in claim 4, which includes the step of generating a delimited text file for each activity, with the element codes, the activity code and the defining parameters of that activity, to define the intermediate file, such that each field of the delimited text file contains one variable element code, the activity code and the remaining element codes.

6. A method as claimed in claim 5, which includes the step of importing data from the delimited text files to imported data tables, such that each row of each imported data table represents a field of the associated delimited text file, with one column of each imported data table containing variable element codes and a number of columns of each imported data table containing said remaining element codes.

7. A method as claimed in claim 6, which includes the step of expanding at least one of the element codes representing a group of workplace elements into element codes representing the workplace elements of that group.

8. A method as claimed in claim 6, which includes the step of importing start and finish time details into a column of the imported data table.

9. A method as claimed in claim 7, which includes the step of carrying out a look-up operation on the registration database and the imported data tables and generating save tables so that each save table has a column of activity codes and columns of workplace element details and so that each activity code can be associated with a set of workplace element details.

10. A method as claimed in claim 9, in which the step of applying predetermined algorithms to the element data and the activity data to generate reports includes the step of calculating cost components associated with various workplace activities and generating account reports.

11. An apparatus for processing data for the administration of an organisation, the apparatus including
a data storage device storing element data representing details of workplace elements;
at least one recordal device that is configured to record activity data associated with the workplace elements by recording the element data during workplace activities associated with the workplace elements;
and at least one computer that is operable on the data storage device, is connected to the, or each, recordal device, is programmed to write the activity data to the data storage device, to generate activity codes associated with the activity data and to write said activity codes to a database in the data storage device together with said activity data, the, or each computer being further programmed to retrieve the element data and the activity data from the database using said activity codes and to apply predetermined algorithms to the element and activity data to generate reports relating to workplace activities associated with the workplace elements.

12. An apparatus as claimed in claim 11, in which the apparatus includes a primary computer and at least one secondary computer connected to the primary computer with a suitable network.

13. An apparatus as claimed in claim 12 in which the primary computer is programmed to generate the activity codes and to store the activity and element data together with the associated activity codes in the data storage device.

14. An apparatus as claimed in claim 13 in which the primary computer is programmed to apply said predetermined algorithms to the element and activity data to generate the reports.

15. An apparatus as claimed in claim 12, in which the data storage device stores a registration database that includes at least one look up table that stores element codes and the element data such that each element code represents a predetermined component of the element data associated with that element code.

16. An apparatus as claimed in claim 15, in which one of the primary computer and the, or each secondary computer is programmed to generate barcodes, each barcode representing an element code and capable of being operatively applied to each workplace element.

17. An apparatus as claimed in claim 16, in which the, or each, recordal device is a programmable barcode scanner that is connected to the, or each, secondary computer via the network.

18. An apparatus as claimed in claim 17, which includes a plurality of barcode scanners capable of reading said barcodes and being configured to generate a signal representing the element code corresponding to the scanned barcode.

19. An apparatus as claimed in claim 18, in which each barcode scanner is programmed to be associated with a particular activity, such that each barcode scanner is configured to read barcodes in a predetermined order when that activity is carried out.

20. An apparatus as claimed in claim 15, in which the primary computer is programmed to write the element codes to intermediate files together with defining parameters, such that each activity is associated with an intermediate file.

21. An apparatus as claimed in claim 20, in which the primary computer is programmed to generate a delimited text file for each activity, with the element codes, the activity code and the defining parameters of that activity, to define the intermediate file, such that each field of the delimited text file contains one variable element code, the activity code and the remaining element codes.

22. An apparatus as claimed in claim 21, in which the primary computer is programmed to import data from the delimited text files to imported data tables, such that each row of each imported data table represents a field of the associated delimited text file, with one column of each imported data table containing variable element codes and a number of columns containing said remaining element codes.

23. An apparatus as claimed in claim 22, in which the primary computer is programmed to expand at least one of the element codes representing a group of workplace elements into element codes representing the workplace elements of that group.

24. An apparatus as claimed in claim 22, in which the primary computer is programmed to import start and finish time details into a column of the imported data table.

25. An apparatus as claimed in claim 23, in which the primary computer is programmed to carry out a look up operation on the registration database and the imported data tables and to generate save tables, so that each save table has a column of activity codes and columns of workplace element details and so that each activity code can be associated with a set of workplace element details.

26. An apparatus as claimed in claim 25 in which the primary computer is programmed to calculate cost components associated with various workplace activities and to generate account reports.

27. A computer for processing data for the administration of an organisation, the computer including a data storage device storing element data representing details of workplace elements the computer being connectable to at least one recordal device that is configured to record activity data associated with the workplace elements by recording the element data during workplace activities associated with the workplace elements, the computer being programmed to be operable on the data storage device, to write the activity data to the data storage device, to generate activity codes associated with the activity data and to write said activity codes to a database in the data storage device together with said activity data, the computer being further programmed to retrieve the element data and the activity data from the database using said activity codes and to apply predetermined algorithms to the element and activity data to generate reports relating to workplace activities associated with the workplace elements.

28-30. (canceled)
